(19) United States
(12) Patent Application Publication
(10) Pub. No.: US 2018/0167257 A1
(43) Pub. Date: Jun. 14, 2018

(54) METHODS AND SYSTEMS FOR FORMING NETWORK CONNECTIONS

(71) Applicant: Ray W. Sanders, Los Angeles, CA (US)

(72) Inventor: Ray W. Sanders, Los Angeles, CA (US)

(21) Appl. No.: 15/699,822

(22) Filed: Sep. 8, 2017

Related U.S. Application Data
(60) Provisional application No. 62/385,170, filed on Sep. 8, 2016.

(51) Int. Cl. H04L 29/08; H04W 8/00; H04L 29/06; H04W 84/18; H04L 12/751

(52) U.S. Cl. CPC H04L 29/08324; H04W 8/005; H04L 63/0272; H04L 12/2859; H04L 69/161; H04L 45/02; H04W 84/18

(57) ABSTRACT

Systems and methods for forming network connections are described. Embodiments of the systems and methods can include identifying a plurality of network nodes in a network system; partitioning the plurality of network nodes into a disjoint network element; identifying, based on the disjoint network element, a first virtual connection between an entry node and an exit node; assigning a first bandwidth to the first virtual connection; and forming a connection domain among the partitioned plurality of network nodes, the connection domain including the first virtual connection.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application is related to U.S. application Ser. No. 13/791,709, filed Mar. 8, 2013, titled “APPARATUS AND METHODS OF ROUTING WITH CONTROL VECTORS IN A SYNCHRONIZED ADAPTIVE INFRASTRUCTURE (SAIN) NETWORK,” now issued as U.S. Pat. No. 9,137,201, the disclosure of which is hereby incorporated by reference in its entirety (hereinafter referred to as the '709 app).

### BRIEF DESCRIPTION OF DRAWINGS

FIG. 1 shows a metropolitan area network example with 20 T-Nodes & 80 simplex trunks according to an embodiment. FIG. 1 corresponds to FIG. 5 in the '709 app.

FIGS. 2, 3, and 4 show various configurations of E-Nodes and their T-Node parents according to certain embodiments. FIG. 2-4 correspond to FIGS. 4.1-4.3 respectively in the '709 app, and further described therein.

FIG. 5 shows an illustration of network objects used to pass user data from a source E-Node to a source parent (routing) T-Node through forwarding T-Nodes (as needed) to a destination parent T-Node to a destination E-Node according to an embodiment. FIG. 5 corresponds to FIG. 6 in the '709 app, and further described therein.

FIG. 6 shows source E-Nodes connecting to parent T-Node T3 according to an embodiment. FIG. 6 corresponds to FIG. 6.1 in the '709 app, and further described therein.

FIG. 7 shows forwarding switches in a SAIN architecture according to an embodiment. FIG. 7 corresponds to FIG. 6.2 in the '709 app, and further described therein.

FIG. 8 shows a cross-connect switch according to an embodiment. FIG. 8 corresponds to FIG. 6.3 in the '709 app, and further described therein.

FIG. 9 illustrates a T-Node T7 level 4 forwarding switches connectivity diagram according to an embodiment. FIG. 9 corresponds to FIG. 6.4 in the '709 app, and further described therein.

FIG. 10 shows forwarding switches in a SAIN architecture according to an embodiment. FIG. 10 corresponds to FIG. 6.5 in the '709 app, and further described therein.

FIG. 11 shows destination E-Nodes connecting from parent T-Node T11 according to an embodiment. FIG. 11 corresponds to FIG. 6.6 in the '709 app, and further described therein.

FIG. 12 shows an example aggregation switch stack selector.

FIG. 13 shows an example disaggregation switch stack selector

FIG. 14 shows an example of Level 2 addresses utilized for Path Level 1 traffic.

FIG. 15 illustrates an example of a network with routers and out-of-order delivery.

FIG. 16 illustrates an example of a one-hop physical connection.

### DETAILED DESCRIPTION

SAIN networks are underlays for current and future networks. It has benefits in at least eight aspects of networking:
1. Latency
2. Scalability
3. Simplicity
4. OPEX/CAPEX
5. Synchronization
6. Security & Privacy
7. Availability & Survivability
8. Bandwidth & Energy Efficiency

Various embodiments of a Synchronized Adaptive Infrastructure (SAIN) networks are disclosed herein. Such a network includes one or more trunk node that can be referred to as T-Nodes; and egress nodes that can be referred to as E-Nodes. SAIN switches (hereinafter referred to as “Sswitches”) operate in source and destination pairs. A source Sswitch (an sSswitch) can connect to a destination Sswitch (a dSswitch) in a single hop. Accordingly, a single hop in a multi-tiered SAIN network can be obtained. For example, an Sswitch can:
1. set up a plurality of connections between two locations as a source Sswitch (referred to as an sSswitch) and as a destination Sswitch (referred to as a dSswitch) pair,
2. act as an sSswitch aggregator and dSswitch disaggregator of a plurality of connections,
3. act as forwarding sSswitch-dSswitch pairs of a plurality of connections over links in trunks between T Node pairs,
4. operate in frames of small amounts of data called cellets each of which represents a quantum of data bandwidth,
5. operate in the algorithm's transform of a Connection Domain that defines the bandwidth of each connection by the number of its cellets in a frame and a Space/Time Domain that spreads cellets of a connection nearly uniformly throughout the frame,
6. define the total amount of bandwidth allocated to a plurality of connections by total number of cellets in a frame,
7. change the amount of bandwidth allocated to each connection dynamically frame by frame,
8. divide frames of connections into two parts—the transform domains and separately. A Control Vector to manage the bandwidths of the connections and their other parameters out of band.

An S switch can accept data from sources at one location and deliver them directly through a dSswitch to sinks at another location. Synchronization and levels of aggregation are major aspects in packet switched SAIN networks. The Sswitches are used to connect source Network Interface Controllers (sNICs) or their equivalent to dNICs.

There are two use case types of sSswitch-dSswitch pairs. A Type I sSswitch-dSswitch pair aggregates a plurality of data connections at one sSswitch location; and delivers the aggregation to a dSswitch that disaggregates the plurality of connections into sinks at another location. A Type I aggregation can travel through one or more serial Type II forwarding sSswitch-dSswitch pairs. In other words, the two types of use of Sswitches can provide routing through multiple connections of sT Node to dT Node links. In this way, a Type I sSswitch connects to a dSswitch as a connection within an aggregation traveling through one or more Type II sSswitch-dSswitch pairs as a single hop.

In one embodiment, a connection can represent a stream bits between two end-points. Packet protocols, if any, may appear at ingress and egress nodes. The Type I source-destination pair appears to be a one-hop aggregation connection in a plurality of connections

A SAIN network can accept user data at a source location and deliver the data transparently to a destination location. In various embodiments, external user data to a SAIN network can be connected in any type of communication protocol. One of the reason for the purpose of a SAIN network is that all forwarding of data is agnostic to user protocols. The following are a few examples:
1. packet traffic such as link-level Ethernet format that encapsulates Internet Protocol (IP) or other format data,
2. aggregations of packet traffic such as aggregations of optical lanes at very high data rates,
3. wireless traffic such as Wi-Fi, 3G, and LTE,
4. circuit-based traffic such as voice, mp3, and MPEG.

Generally described, network data can appear in formats configured for switching or transmission in Network Interface Controllers (NICs) (e.g., as described in other related patents and patent applications such as U.S. Provisional App. No. 61/298,487, filed Jan. 26, 2010, titled “APPARATUS AND METHOD FOR SYNCHRONIZED NETWORKS; and U.S. application Ser. No. 13/013,717, filed Jan. 25, 2011, titled “APPARATUS AND METHOD FOR SYNCHRONIZED NETWORKS,” now issued as U.S. Pat. No. 8,635,347). NICs can involve either hardware or software emulations in data servers or other processors. Like other forwarding objects in a SAIN network, a source NIC (sNIC) pairs with a destination NIC (dNIC). A connection between the two is disjoint from all other connections.

Other methods of building communication systems or other devices exist. Any system or device containing the SAIN S switch algorithm or similar scheme is by definition a SAIN system or device.

A SAIN network can have one or a plurality of aggregation levels. Each level can use the same sSswitch (i.e., sSswitch/dSswitch pair) basic structure for each level. Aggregation and/or forwarding may be implemented in a hardware device (e.g., a network switch) or in software instructions stored in memory configured to be executed by a processor. As described herein, a SAIN network can be a plurality of sub-network partitions of the large network. A SAIN network partition can be a disjoint plurality of SAIN sSswitch/dSswitch pairs so that it is disjoint from all other partitions and data connections. For example, a control vector can specify a partition of network nodes that form a disjoint network element. This can be referred to as a connection. That disjoint network element specifies a source (e.g., an entry node) and a destination (e.g., an exit node). The disjoint network element is not impacted by another disjoint network element (e.g., a different connection). Only a control vector can change the sources and addresses of disjoint network elements, thereby altering a connection. By specifying disjoint network elements in a SAIN network, network data communications can be transmitted in a deterministic manner. In various embodiments, a single partition or a plurality of partitions can be a private network. A private network that is a plurality of private partitions can be divided into private sub-networks. For example, such private sub-networks may correspond to various divisions of a company.

Some exemplary levels of aggregation in a SAIN network include:
1. Path Level 1 Aggregation/Disaggregation: This level sSswitch can aggregate sNIC or sNIC-like input data such as that shown above and changes it into the SAIN forwarding protocol. The aggregation can travel through one or a number of methods to connect to the paired dSswitch that can disaggregate the forwarding protocol into its initial form. Path Level 1 can aggregate any number of sNIC-like inputs by either using a Virtual Entry/Exit (a VE-Node) or aggregating a small number of Path Level 1 inputs as a subpart of an E-Node.
2. A Level 2 Aggregation/Disaggregation (sSswitch-dSswitch pair) is associated with a SAIN network object and can be called an Entry/Exit Node (an E-Node). The purpose of an E-Node is to aggregate Path Level 1 packets and data flow aggregations into a next higher aggregation/disaggregation level. Each E-Node can contain a sE-Node with a plurality of sSswitches each of which connects to a dSswitch in a dE-Node that is either in the same or in a different SAIN network partition. In some high traffic cases, any E-Node can require a connection with every other E-Node in a plurality of E-Nodes in the same or in another partition.
3. A Level 3 Aggregation/Disaggregation is associated with forwarding a plurality of all sE-Node Level 2 aggregations nominally between T-Nodes. This description of forwarding traffic in a SAIN network starts below, starting with a simple case to a large network case including among others routing alternatives.

In various embodiments, T-nodes can include a plurality of connections to a plurality of other T-nodes. E-nodes can then be aggregated at an origin T-node, and then transmitted based on their destination using at least one of the plurality of connections to other T-nodes. In one embodiment, if a T-node has five E-nodes, two of the five E-nodes can be communicated via one connection to another T-node; and the remaining three of five E-nodes can be communicated via a different connection to a different T-node. Accordingly, various methods of aggregation can be accomplished at a particular T-node for destinations across the network to different T-nodes, using various routes.

### Where NICs can Exist in a SAIN Network

A sNIC can be virtually available to several dNICs that are in partitions entered from a sNIC's source partition. For example, in one embodiment, a sNIC can be available to all dNICs. Each sNIC may be required to meet some methods or restrictions that enhance security and privacy for authorized uses. For example, such methods or restrictions can include:
1. meet private partition restrictions, and/or
2. meet physical location restrictions, and/or
3. meet user authorization controls, and/or
4. use restricted encryption methods, and/or
5. meet Control Vector restrictions, and/or
6. assure that dNIC meet sNIC verification updates, and/or
7. meet biological aspects (e.g., bio-data, fingerprints).

A sNIC can be capable of connecting to more than one dNIC simultaneously or at least in a round robin fashion. sNICs and their ports can be available directly or indirectly to E-Nodes. This can enable a NIC access to a Path Level 1 aggregation to parent E-Nodes. As the number of sNICs can be required to multi-connect to dNICs at many places in SAIN network possibilities, in some embodiments, it may be desirable to have all sNICs and their ports to be available directly or indirectly to E-Nodes. This would also enable sNIC access to sVE-Nodes that can connect to parent E-Nodes.

A SAIN Network can Use a Single VE-Node with a Single E-Node

In some embodiments, to complete a connection between a sNIC-dNIC with a single parent Path Level 1 can occur with a Path Level 1 sSswitch connects physically to a dSswitch in Path Level 1. For example, a clocked connection can come from a parent E-Node's sE-Node-dE-Node pair. In this manner, the sSswitch-dSswitch pair could support a plurality of sNIC-dNIC connections within the Path Level 1.

One or more clock sources can exist in any SAIN network such as 1) a master clock sets the frequency, or 2) a master clock sets phase and frequency, or 3) a plurality of nodal clocks that operate at nearly the same frequency with variable phase. Disclosure of such methods exists in a prior patent application.

A SAIN Network with a Plurality of E-Nodes and a Single T-Node

A SAIN network can include a single parent T-Node with a plurality of child E-Nodes. The T-Node can include a source T-Node (sT-Node) and a destination T-Node (dT-Node). Likewise, each E-Node can contain a source E-Node (sE-Node) and a destination E-Node (dE-Node). The purpose of an sE-Node is to aggregate all Path Level 2 connections that originate in the source E-Node's source NICs (sNICs) that connect to one or more destination NICs (dNICs) in each of the network's dE-Nodes.

If there are N E-Nodes connected to the single T-Node, there will be an aggregation of either N or N−1 Path Level 1 aggregations. There will be N if all E-Nodes in the network if the sNICs of the sE-Node that connect with the dNICs of the sE-Node are included. There are N−1 if the sE-Node's dNICs are excluded since they can be included in the single E-Node network disclosed above.] As described herein, there is an assumption that N Path Level 2 aggregations create a Level 2 aggregation. In other words, since there are N E-Nodes each with N Path Level 2 aggregations, there are a total of N2 Path Level 2 aggregations in the network.

What the sT-Node receives from each of the connected sE-Node Level 2 aggregation is one Path Level 2 aggregation for each of the dE-Node Level 2 disaggregations. Accordingly, a Crossconnect function can take place between the sT-Node and the dT-Node. This function can interconnect dSswitch-sSswitch combinations.

Numbering each sE-Node as sE-Node 0 to E-Node N. The number of each Level 2 aggregation element from sE-Node 0 sE-Node 00, sE-Node 01, . . . sE-Node 0N. Each first number shows the number of the sE-Node. The second number is number of the dE-Node to which the Level 2 aggregation element belongs.

### How an E-Node Pair can Contain Both a Level 1 and Level 2 Aggregation.

An E-Node can be the parent of a large number of NICs, both sNICs and dNICs. However, that does not mean that there will be a large number of connections between a sE-Node in one SAIN network partition and dE-Node in every other. This might occur in a large organization such as a company or a government entity. In such instances, it is not necessary to set up a Path Level 1 pair—one in the sE-Node and one in the dE-Node. The sE-Node could be in one partition and the dE-Node in another partition. In a SAIN network, every sNIC could have a virtual connection with every dNIC. However, such a connection can only exist where the sNIC and dNIC exist in the same partition or sub-partition or meet special authorization to consummate a connection. Some of the authorization embodiments are included herein.

A SAIN Network with a Plurality of E-Nodes and a Plurality of T-Nodes

In some embodiments, there is one major difference and one small difference between “A SAIN network with a plurality of E-Nodes and a single T-Node” and “A SAIN network with a plurality of E-Nodes and a plurality of T-Nodes.” The major difference can be that the single T-Node network is a single partition. The plurality of T-Nodes can be a partition with a plurality of sub-partitions. If there are 20 T-Nodes in a network, each one considered by itself can be one of 20 independent networks. Considering all 20 as a network together is a major difference. Each of the 20 partitions can interconnect only where mutual NIC authorization exists including methods such as those outlined in paragraph [0006] above.

### Routing in a SAIN Network

Comparing Routing in a SAIN Network with the Current Internet

Current packet networks rely on complex hop-by-hop methods such as Ethernet protocols (often labeled as OSI ‘Layer 2’) and Internet protocol networks (often labeled as OSI ‘Layer 3’). In contrast, SAIN networks can connect and transfer any protocol receivable by a sNIC and deliverable by a dNIC. What is receivable at a sNIC can be any OSI protocol layer. Packet traffic at any OSI layer entering a sNIC connected to an sSswitch can be the same OSI layer being delivered at a paired dNIC.

### The Two Methods of Synchronization Available in a SAIN Network

Synchronization can be an important parameter in some embodiments of a SAIN network. In some embodiments, it can be important when it comes to forwarding routes in a network. As two examples, some methods can achieve synchronization: One is to time-align all routes with one another; and the other is to use the SAIN method of aligning each aggregation stream with a framing method.

### Advantages of Partitions

A SAIN network can be divisible into partitions. In some embodiments, this has three advantages: 1) it can assure security and privacy of private networks; 2) it can simplify routing by using a method of aligning aggregations; and 3) such a method can further assure security and privacy.

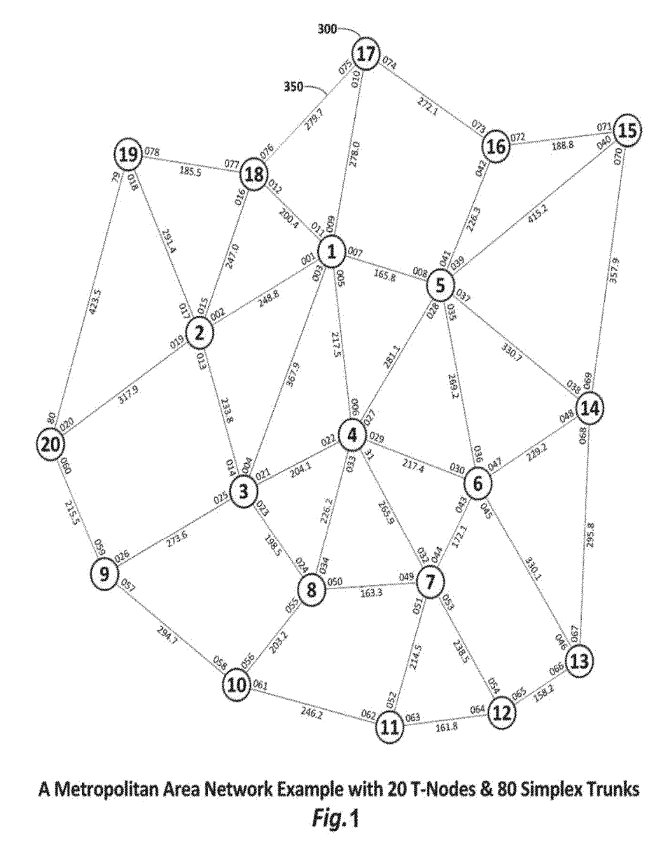

FIG. 1 depicts a 20-T-Node model used for illustrating the methods of SAIN networking. One aspect of SAIN can be to divide a network into partitions each of which can contain a T-Node as shown in the figure. FIG. 2 shows an example of connected T-Nodes including a cluster of E-Nodes, each of which is connected to the T-Node as its parent.

A partition includes a cluster of E-Nodes connected to a parent sT-Node. Each E-Node can easily have their switch synchronizing all of the sE-Node-to-dE-Node connections. But, in some embodiments, because many of the synchronized connections are important, the distance of one sE-Node from a parent sT-Node in a partition is not the same as another. If the time-aligned method of synchronization is used, it can require that the systems must delay all aggregation streams to be time aligned with the most delayed stream. Accordingly, this method of framing removes the need for such delays.

### Defining Possible Structures in a SAIN Network

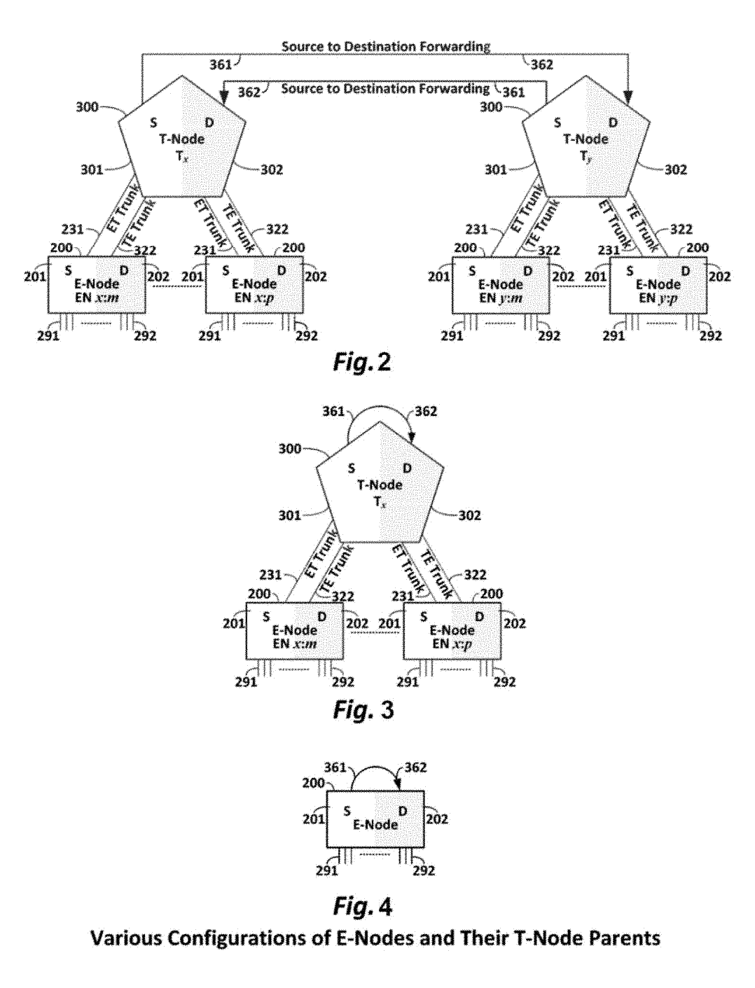

In a SAIN network, each E-Node can have a virtual connection not only with every E-Node in the network, but also with every E-Node in a more global sense. FIG. 1 depicts one embodiment of this connectivity. For example, FIG. 3 shows a partition made up of a single T-Node. Further, FIG. 4 shows how a T-Node in one partition can connect to a partition with a different T-Node. Assumed is that each E-Node connects through ports to a subset of all NICs in a network. In other words, any NIC in connected to an E-Node can have a virtual connection to every NIC in a SAIN network.

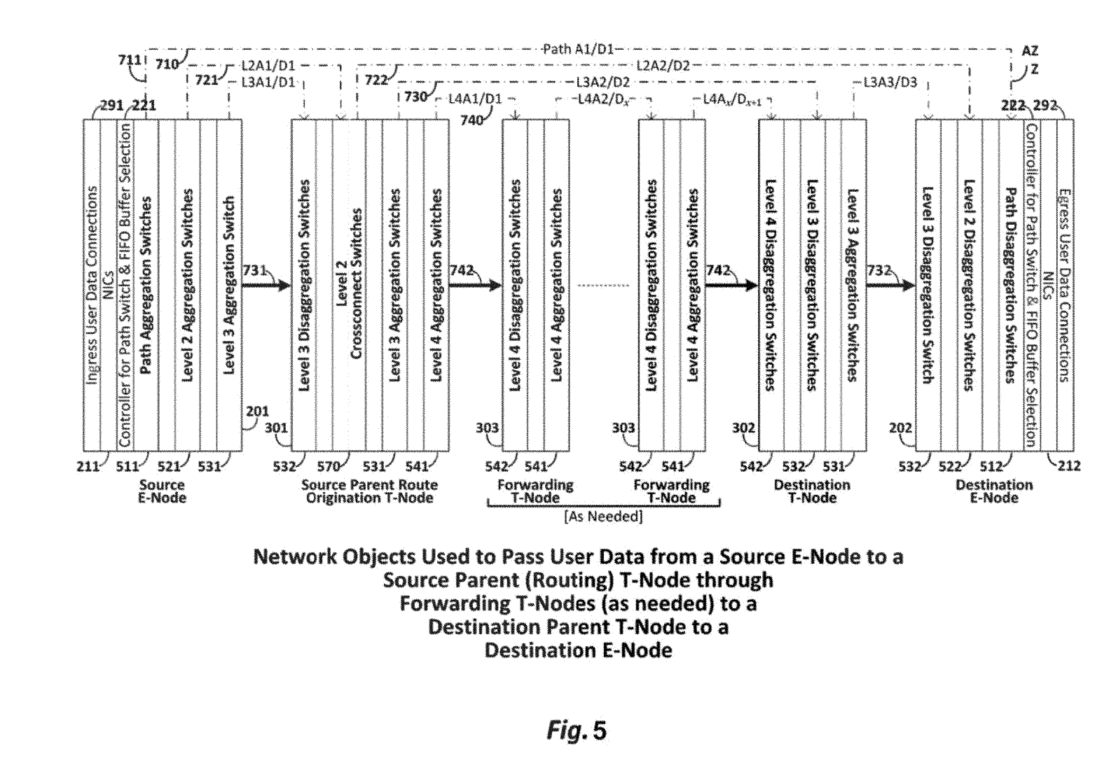

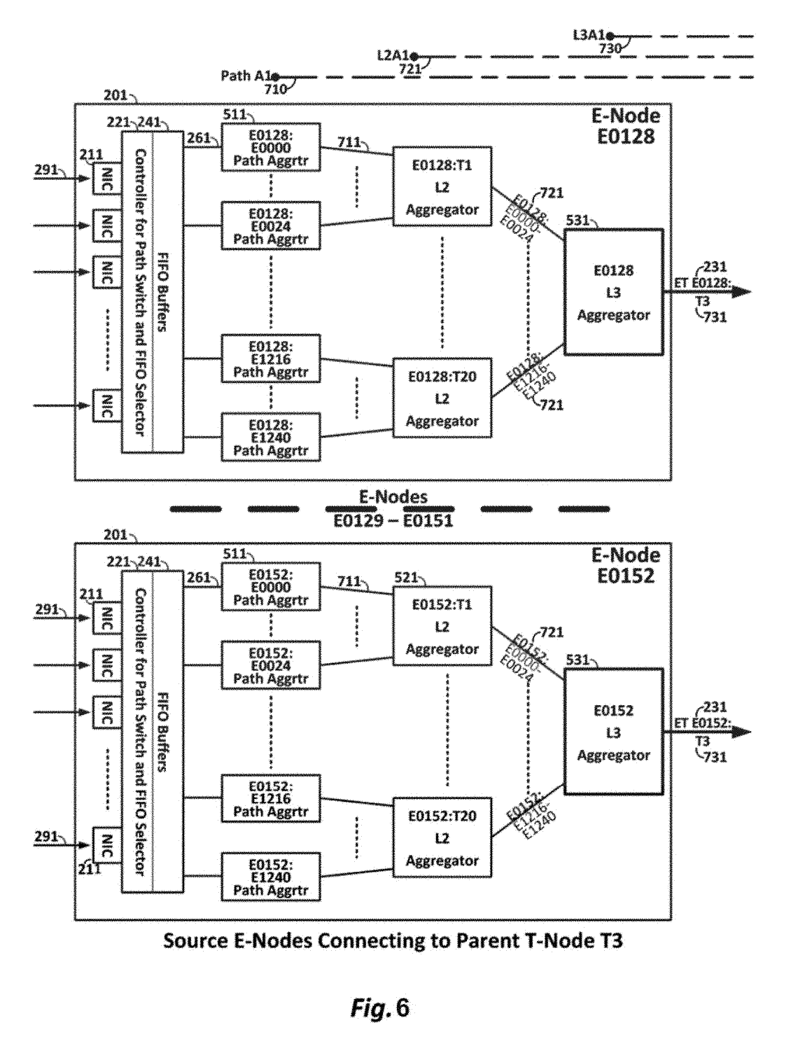

A SAIN network aggregates data inputs from users into sNICs that connect to a paired dNIC in a single hop. The connection can exist within a plurality of other connections within aggregations of connections. There are virtual connections in a SAIN network between any two E-Nodes within a SAIN network or even in E-Nodes in other SAIN networks. The aggregations that exist within a pair of E-Nodes are Layer 2 in the model network. Each Layer 2 aggregation contains all connections between those sNICs that are sending to a dNIC that connects to a paired dE-Node. Routing in a SAIN network leads each such Layer 2 aggregation of Path Level 2 connections. For example, FIG. 5 shows an illustration of network objects used to pass user data from a source E-Node to a source parent (routing) T-Node through forwarding T-Nodes (as needed) to a destination parent T-Node to a destination E-Node according to an embodiment. As another example, FIG. 6 shows source E-Nodes connecting to parent T-Node T3 according to an embodiment.

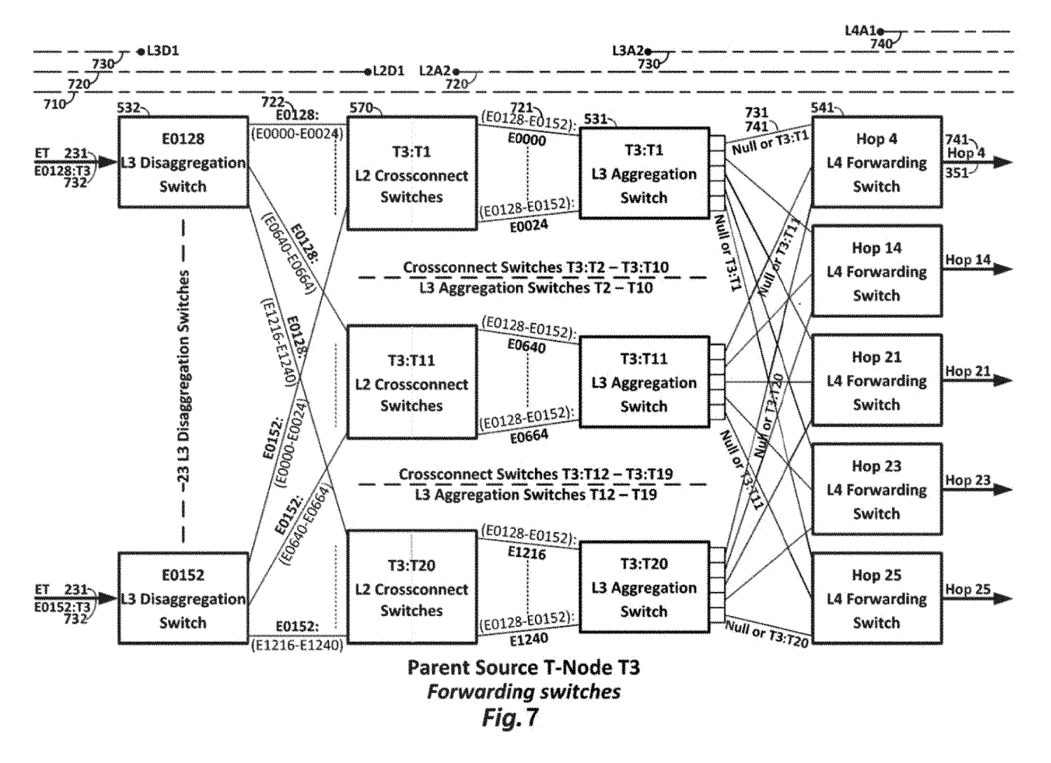

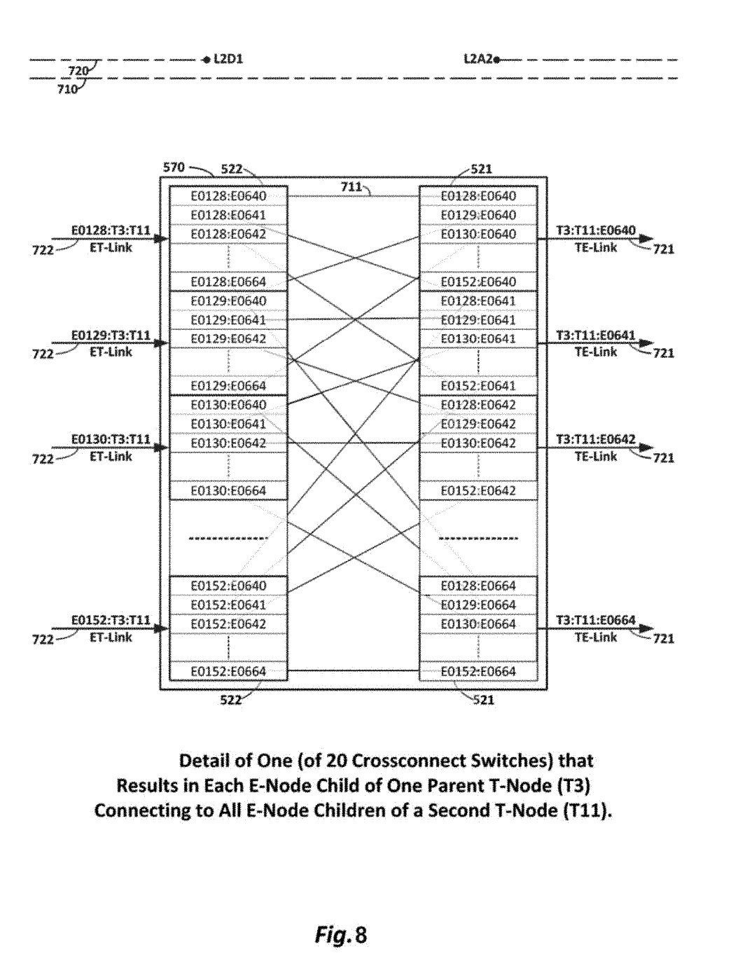

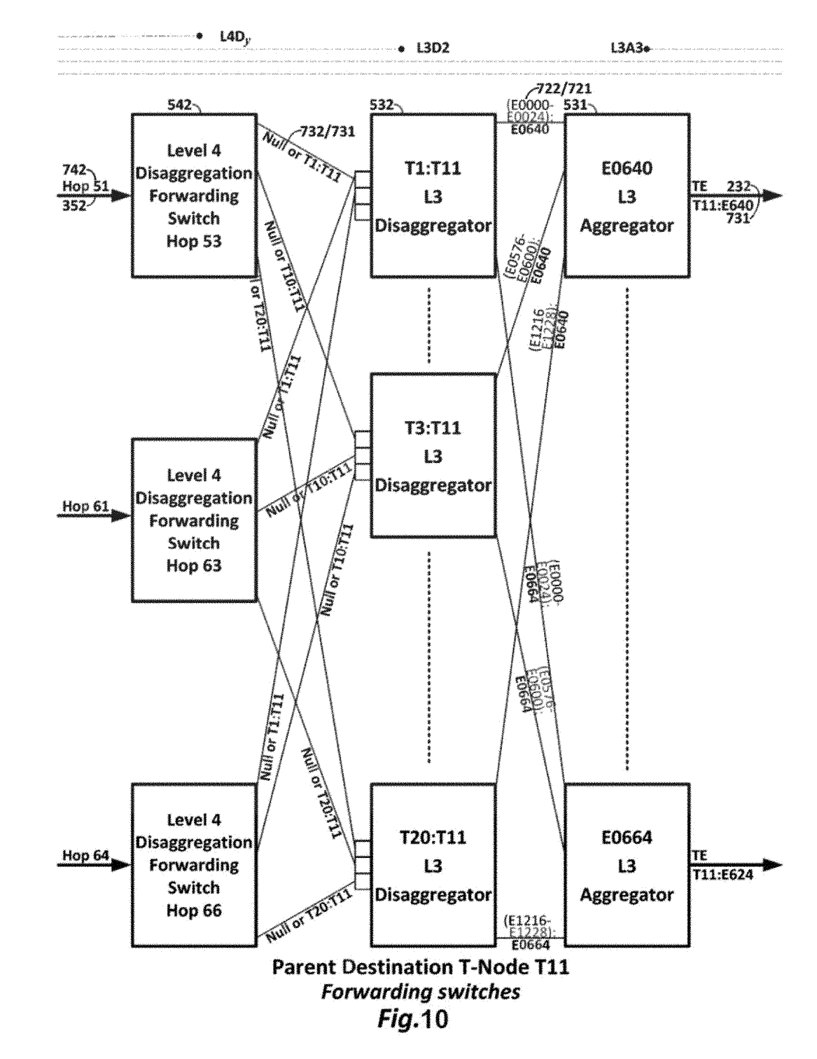

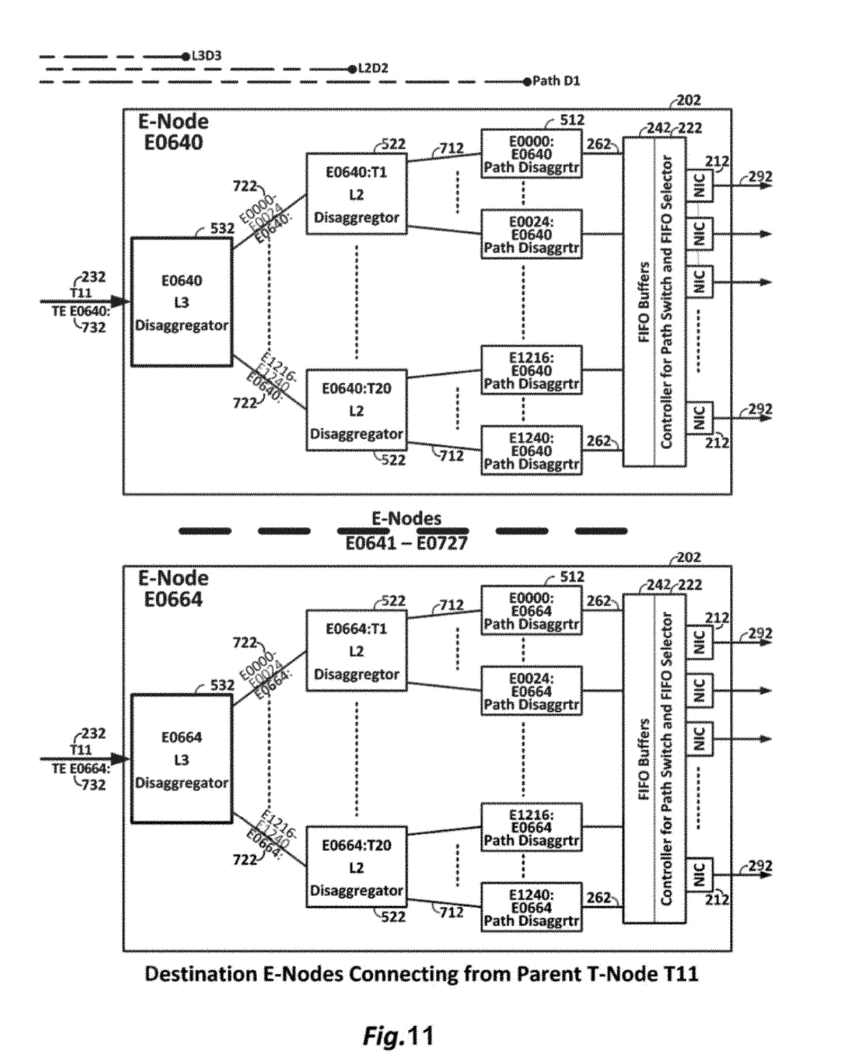

In an exemplary embodiment, A SAIN network, as shown in FIGS. 7 to 10, illustratively depicts how routes can be set up. Each of the Level 2 aggregations goes from each sE-Node with parent sT-Node 3 connecting to dE-Nodes with parent dT-Node 12. FIG. 1 shows the scene of all 20 T-Nodes and all 80 simplex trunks in a model network. Many possible routes exist between sT-Node 3 and dT-Node 12.

FIG. 7 shows there are five possible connections to each of the five outbound trunks (4, 14, 21. 23, 25) at parent sT-Node 3. A route can start over any one of the five. A table of routes between the source and destination can show the combination of latency and available bandwidth of each of the routes. The source route sT-Node 3 can provide guidance at every other T-Node of its role in a route if any. The messages are contained in (part of) a Control Vector (CV) message sent to those nodes that are going to forward a specific Level 2 route. The route can be set up once, but also monitored to assure continuously that it is working. In some embodiments, if it is not, another possible disjoint route exists in a virtual state so that only a very small amount of data need be lost.

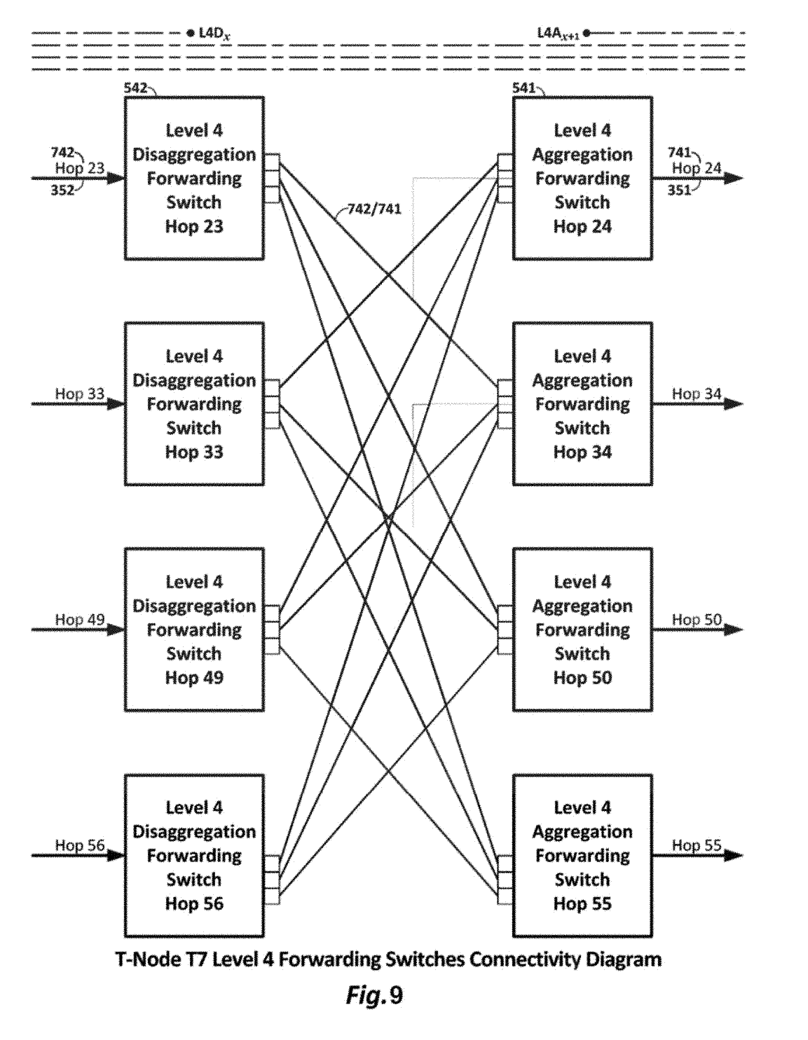

Each source sT-Node of what are Type II aggregator/disaggregator has at least one switch pair at every forwarding node for the number of possible connections to each possible next aggregation hop. Each switch can have a reserved position in a Circuit Domain for the route. For example, the Level 3 source aggregation node as chosen in FIG. 9 is trunk 23. The bandwidth for the connection can change periodically as it does for any point-to-point connection. There are always two states of activity about the amount of bandwidth allocated to a connection. In this case, there can be two state locations ‘A’ and ‘B’. If state location ‘A’ is active, state location ‘B’ is preparing for the next frame.

### Method of Removing Non-Message Part of a Packet with Extension of Past Connection Memories

User connections between a data source and a data sink can take advantage of a SAIN network type of system that can reduce using system bandwidth, increase network security, and reduce processor demand. The method can apply to many applications. An example used herein connects source NICs (sNICs) to destination NICs (dNICs) through a SAIN network with its transparent forwarding.

As a few exemplary examples, objects that can implement the methods include:
1. A sNIC connected to a dNIC through a SAIN transparent network
2. A data hash processor of a defined non-message portion of a data packet
3. Table of current virtual and real connections with hash table numbers
4. Hash table of past connected packets
5. Last sNIC-dNIC connection tables showing data sizes and time stamps.

The connection between a sNIC and a dNIC can be included in the sE-Node to dE-Node Level 2 aggregation that carries the appropriate Path Level 2 aggregation. The Path Level 1 aggregation 1) connects to an sSwitch in either a Path Level 1 connected to the Path Level 1 that connects to dSswitch in either a Path Level 1 connected to a dE-Node, or 2) to a plurality of connections that are included as sub-connections of Level 2 sSwitch to dSswitch connections.

In some embodiments, steps can be taken to before operation of the exemplary method:
1. Aspects of packets forwarded through network to include 1) source and destination addresses and 2) other defined non-message parts.
2. Determine number of hash entries in two columns, one relatively short and a longer one. For example, the short column can be taken to hold 256 sNIC-dNIC positions. As another example, a longer column can hold 4096 sNIC-dNIC positions. This can become an empty long after the 256 position short column has been deleted, with the oldest entry put into place as the newest entry.

Exemplary steps can further include the system sending packets through a SAIN network:
1. Use headers to divide the packets into 1) source and destination addresses and 2) protocols less CRC, message, and other defined variable parts into separate memory locations.
2. Process the resulting second part into a hash number.
3. The first hash appears in a three-column table, 1) one for the hash number (such as 64 or 128 bits), 2) a second for the location position number in the Circuit Domain of the sSswitch-dSswitch pair, 3) and the third is the time order of the row in which the packet last appeared. The first column (the hash number) sorts the table in hash-number-order from small to large number.
4. Initially, there are no entries in any column of the table. A first entry will be on the first row where the hash number occurs in the first column, the location position number in the second, and a zero in the third. [Instead of a fourth column in the table, there is a separate large column of hash numbers and their source values.]
5. The next packet will provide either a hash number (or less likely, a ‘yes’ or ‘no’ comparison on all of the values) for the packet source values. If the second packet is not the same as the first, all existing rows including the existing packet raise the third column value by ‘1’.
6. In one exemplary scenario, for each succeeding packet, if it is different from any prior packet, that will cause all other packets to increase their time order value by one.
7. If an entering packet is the same as a previous packet, the situation is different. The old packet's time order number is stored where the value can be used to determine whether or not each prior packet's time order value should be incremented by one or not. For each row in the three-column table, if the row in the third column table is less than the stored value, increase the value in the third row by ‘1’. If the value equals the stored value, replace the old value by ‘0’.
8. The number of rows in the three-column table is generally set up before use of the system. If a new packet appears and the number rᵢ rows equals the setup value, the last row memorialized the packet disappears with removal of the last row. A new first row becomes added as a new first row with a third column time order value of ‘0’.

A second table can be set up that is much larger than the one that is desirable for Circuit Domains in sSswitches and their paired dSswitches. Such a table can include the three columns described above. A fourth column can store matching data that led to a hash number.

If we limit the number of possible connection numbers to 256 (i.e., the first table), the Control Vector needs to identify one byte per connection. The connections can be virtual or real and if they are virtual, they can be set to using zero bandwidth for their bandwidth.

Suppose that the second number of past packets is 4,096. This method can enable matching current hash numbers with the past packets.

The systems and methods herein describe a new way of routing and forwarding connections with new architecture systems that can provide certain useful services, for example, providing access for large private networks, providing access to special services to many organizations such as large companies and government agencies. In some embodiments, this can occur in connection with wireless networks or optical networks.

The need for this approach comes from a fact that real-time flow-based traffic can dominate demands on today's Internet. There is an increasing need for large amounts of streaming data to arrive reliably, on-time and in-order.

In various embodiments, a Synchronized Adaptive INfrastructure (SAIN) is connectivity technology for a new conceptual Internet. The technology can include a very secure underlayer network that provides one-hop end-to-end service at very low latency. It can also use bandwidth efficiently, can be low cost, can be highly scalable, can be survivable, and can have low energy use.

In one embodiment, an application of SAIN network can be for emerging markets such as large private networks and large wireless networks, both of which can be at a global level, and will significantly lower CAPEX and OPEX cost. A connection can be disjoint from every other connection, resulting in superb security without depending on encryption.

As described herein, a SAIN network can support a global environment with a new routing strategy. This starts with a short summary on how a SAIN network works. Then, 1) defines what can cause a real routing problem, 2) show what has been difficult in the past, and 3) how the SAIN approach is much simpler with very low latency, high security and other improved performance.

### How a SAIN Network Works

Packet-based networks send packets one-at-a-time from a source ingress port to a destination egress port. Each packet passes hop-by-hop serially through tunnels or semi-randomly through multiple network links.

In various embodiments, a SAIN network does not send packets one-at-a-time—the network can forward a plurality of packets at the same time in orderly fashion as framed aggregations of packet fragments. A fragment, called a cellet, can be any fixed size (number of bits) for periodic frames. A cellet can represent a quantum of bandwidth that equals the size of a cellet divided by a frame period′. Nominally, frame rates (the inverse of frame periods) can be constant over well-defined periods of use. However, the number of cellets in a frame can be variable. In other words, a frame's bandwidth can vary frame-by-frame as each packet can use bandwidth quanta only as long as portions of a packet exists. In between packet flows, the position of a circuit can remain in place consuming zero bandwidth.

The bandwidth of each circuit and frame can change quickly. How quickly depends on traffic needs. Often, ‘quickly’ can mean 1,000 times per second, i.e., sequentially in one millisecond periods. Changing parameters can, in some cases, require about two milliseconds.

A first millisecond can prepare bandwidth and other parameters of a Connection Domain in SAIN's transform algorithm that has two Domains—a Connection Domain and Space/Time Domain. The Connection Domain can exist in two states: a preparation state and an active state. The preparation state can use incoming data from users and network measurement inputs. Illustratively, once completed, a source node sends a Control Vector out-of-band signaling to a destination to synchronize the source and destination Circuit Domain preparation states prior to activation. Continuing in the same example, both source and destination nodes change to the newly prepared Circuit Domain as soon as the preparation period is finished. The Space/Time Domain can then change, upon changes to the Circuit Domain.

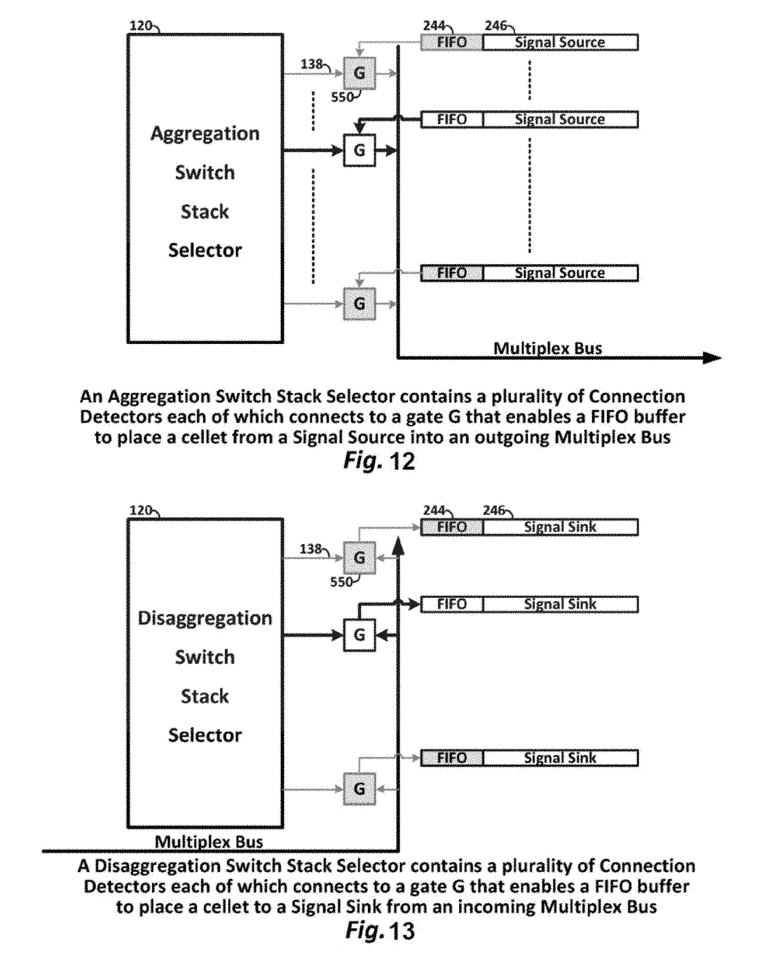

Each circuit in a SAIN network can carry individual packets or sequential packet flows. Each aggregation is a plurality of circuits that can exist in several hierarchical levels. There can be hop-by-hop forwarding of aggregations. A SAIN network can avoid the disadvantages of packet buffer complexity. In some embodiments, buffers exist only at ingress and egress ports. For example, FIGS. 12 and 13 show examples of buffers at aggregation and disaggregation switches that can exist an ingress and egress port respectively. As depicted in FIG. 12, an aggregation switch stack selector can include a plurality of connection detectors, each of which connects a gate that allows a FIFO buffer to place cellet from a source address (e.g., signal source) to an outgoing multiplex bus for the ingress port. As depicted in FIG. 13, an disaggregation switch stack selector can include a plurality of connection detectors, each of which connects a gate that allows a FIFO buffer to place cellet to a signal sink to an incoming multiplex bus for the egress port.

### A Fundamental Cause of any Large Network's Routing Complexity

Illustratively, as any network grows in size, its connectivity can grow in a square-law fashion. For example, suppose that a small network has 20 ports. Each port connects to 19 ports—all ports except itself. Each port has the same number of connections resulting in 20×19=380 connections. Continuing in the same example, if the number of ports increases to 40, a factor of two, the number of connections per port increases to 39 and the network's number of connections become 1,560—nearly a factor of 4. In a fully connected network with n ports, every port can connect to n−1 other ports for a total number of connections equal to n×(n−1). Accordingly, in some embodiments, it may not be possible to connect all source ports with all destination ports for a long period of time (e.g., a fixed or virtual connection). Thus, in some embodiments, it may be advantageous to set up port pairs sporadically, as disclosed below.

The solution for the current Internet uses the idea of an Autonomous System (AS) separation of a network into seemingly arbitrarily small parts. In an exemplary SAIN network (e.g., with a particular structure), each part of a SAIN network may be an Autonomous Partition (AP). A global SAIN network can divide into a number of disjoint partitions each of which may contain disjoint connections between ports. Each partition can connect to another partition in a novel way described below using dual level approaches.

In one embodiment, each forwarding object in a SAIN network can divide into two parts—a source Part (sPart) and a destination Part (dPart). This s/d notation endures herein.

### The Basic Structure of a SAIN Network Connectivity Object Pairs Work

In an illustrative global SAIN network, there can be four tiers of nodes. At each level, there can exist one-hop aggregation/disaggregation switch pairs (aS/dS pairs). An aS/dS switch structure can be the same at any level of aggregation that has a higher aggregation level. An aS can connect to an aS at a next higher tier level or to a dS forwarding switch. A dS can connect to an aS forwarding switch or to a dS at a next lower tier level. A forwarding switch can maintain a tier level of aggregation.

The lowest tier (Path Level 1) can occur in nodes called Virtual Entry/Exit Nodes (VE-Nodes). A source VE-Node (i.e., sVE-Node) can aggregate all circuit connections from data-source ingress ports and connect one-hop to common locations of data-destination egress ports. A destination VE-Node (dVE-Node) can disaggregate circuit connections to data-destination egress ports.

The next higher-level nodes are Entry/Exit Nodes (E-Nodes). These nodes are the core of a SAIN network. Each E-Node can have a virtual connection to every other E-Node in a network or to a connected plurality of networks. Such connections are in an anticipated virtual state that can become a real physical state. In other words, a virtual state connection can have known routes prior to need. Below is a description of the SAIN simple method of this property.

Like all connection objects, a VE-Node and E-Node can each divide into two parts, a sVE-Node/dVE-Node pair and a sE-Node/dE-Node pair. Illustratively, each sE-Node can aggregate Path Level 1 sVE-Node aggregations that enter a sE-Node and terminates in physically connected dE-Nodes that, in turn, can connect to dVE-Nodes that disaggregates into egress port connections.

In various embodiments, a given partition of a global SAIN network can be a cluster of E-Nodes that connect to a parent Transit Node (T-Node). (Other possibilities can interconnect nodes, for instance for redundancy.) Like other tier nodes, each T-Node can divide into a sT-Node and a dT-Nodes. A sT-Node can aggregate separate sE-Node aggregations from its cluster to terminate in each dT-Node cluster in a global network partition. For example, this can include backhaul to a dT-Node in the same T-Node as a sT-Node.

In various embodiments, the bulk of connections in a SAIN network can be these first three tier of nodes. However, in some embodiments, a fourth level tier can be called an eXchange Node (X-Node) with sX-Node and dX-Node parts. An X-Node can sit atop a collection of T-Nodes (e.g., a cluster of T-Nodes) and/or a collection of APs each of which has one or more T-Nodes. An X-node can be located at a data center where data is processed in large quantities. For example, in one embodiment, an X-node can process data at 100 Gbps. Illustratively, in various embodiments, an X-node can be coupled to a fiber optic network or be a part of the fiber optic network, for example, as a switch.

### How a SAIN Network Finds Routes Prior to Use

Prior to use, a simple SAIN algorithm can calculate all possible loop-free routes among T-Nodes prior to use. As a result, a SAIN network can route large enough data aggregations between T-Node pairs so that the Law of Large Numbers can smooth out bursty packets without congestion by changing just enough bandwidth quickly

A controller at each source can choose desirable routes between source and destination nodes from among a large plurality of possibilities. For example, the system measures the available bandwidth of each possible route periodically (e.g., 1,000 times per second). In addition, at installation, the system can have measured the latency of each trunk in the network so that calculating the latency of a route is exists before use. Choosing the lowest latency route with just enough bandwidth for an aggregation (taking into account one-way propagation delay) can minimize the replacement cost, i.e., long-term cost of a network.

The controller can also use multiple routes for source to destination T-Node connectivity. This can provide various ways of overcoming faults and improving management of route bandwidth.

### Wren to Use VE Nodes

As an illustrative example, each E-Node can have data source ports, each of which can send data to destination ports that are in selected network partitions or to the public Internet. Each E-Node can further have data destination ports that may be restricted to selected partitions. In order to maintain public Internet security, a destination NIC or other similar object can restrict data from a selected protocol, such as PDF and perhaps OCR.

A VE-Node can connect to each of its parent E-Nodes with every other node efficiently in a selected partition that will send a large amount of traffic. In one embodiment, a VE-Node can be implemented when data traffic is most homogeneous. For example, this can occur in a SAIN network made up of a plurality of partitions that are set up to encapsulate ports most likely to be sources and destinations of traffic. Such partitions can include areas where people and machines are most likely to communicate with one another.

Large data centers can be such places. Illustratively, they can likely benefit from partitioning into clusters of use. A major benefit of partitioning source ports by class of use for data centers is that that can make best use of server types and storage. Dividing networks into partitions can have another benefit: The number of source E-Nodes can be small so that routing therein is simple.

### Dual VE-E-Node can be within a Single X-Node

In one embodiment, E-Nodes in a network partition can connect to a relatively small number of other E-Nodes both inside and outside selected partitions. In this instance, a sE-Node may need to connect to a limited number of dE-Nodes with a limited number of Path Level 1 connections. Anywhere in a network, there may be times of day with only a small amount of traffic.

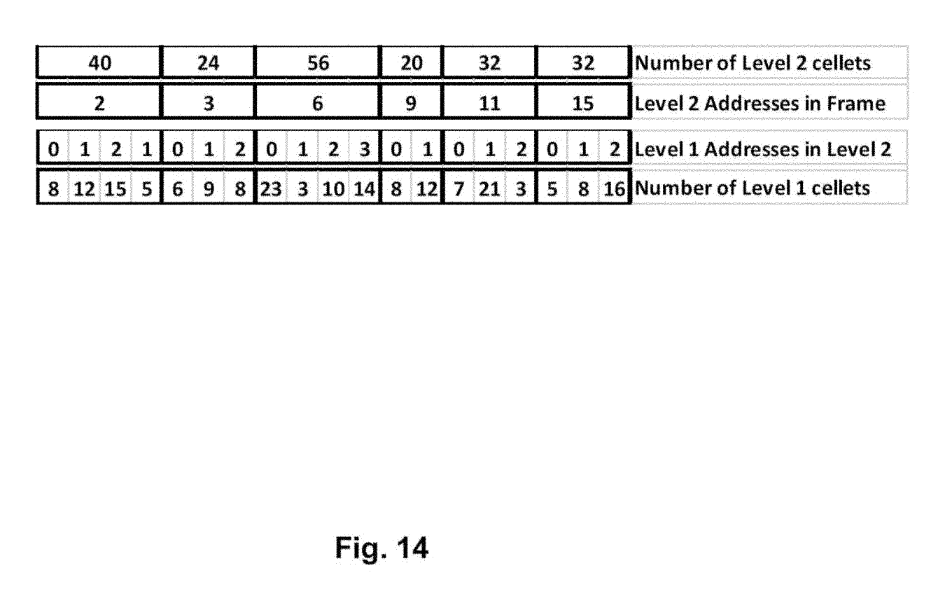

One method of supporting these low traffic conditions can be to use existing Level 2 forwarding and add a Path Level 1 layer to the Level 2 in a frame. FIG. 14 shows, in one embodiment, how this can be implemented.

As described above, VE-Nodes can benefit users clustered together and on the source side of data centers. In this embodiment, the distribution side of a data center can be another application. Dual VE-E-Nodes can come into play. FIG. 14 shows an example of Level 2 addresses that turned on with a number of cellets needed for the Path Level 1 traffic.

These values can use Control Vectors such as employed with larger traffic where Level 2 bandwidth uses 8-bit bytes to in one-bit cellets.

Using modular source and destination switches can extend this method to much more traffic.

### Extending Dual VE-E-Nodes Beyond a Single X-Node

Networks can have distributions (e.g., non-Gaussian probability distributions) that show that clusters of traffic generate more traffic than do widely distributed traffic generators. In many empirical observations, heavy traffic compared to light traffic has something close to 80% of traffic distributing among clusters. In other embodiments, the smaller number outside a cluster can result in widely dispersed traffic.

For a SAIN network, routing and forwarding aggregations can be, in some embodiments, methods to reduce latency, for example, forwarding traffic can be deterministic. In one embodiment, this may result in an optimal condition that reduces latency while forwarding traffic simultaneously. Using SAIN routing techniques may require a higher tier to result in a simple approach. In addition, changing bandwidths of connections over very long distant connections may require using two-way management control of available bandwidth. Reserving bandwidth prior to use can overcome rapidly changing propagation delay.

In various embodiments, other portions of global network can be accessed through T-Nodes. In this example, a T-Node inside a partition can set up connections through its X-Node top tier to another X-Node using SAIN routing techniques. In another example, Partitions selected for interconnectivity can include matching NICs and authorization methods.

### Virtual Connections in Circuit-Based Networks

Systems and methods for providing circuit-centric, frame-based communications, with connections at ingress and egress nodes of a network are described herein. The connections can be configured based on network load, with some connections appearing as virtual connections in a “sleep state” if network load decreases. For example, in a fiber optic network, the connections can be configured for communication on particular wavelengths in combination with “virtual circuits,” alternating between active and sleep states as network load requires.

Virtual connections can exist between E-Nodes and their respective ports and/or their respective NICs. In some embodiments, the bulk of the virtual connections can be sleep mode that can become real (e.g., active). For example, in one embodiment, a couple of milliseconds plus (probably one-way) propagation delay can transition a virtual connection from sleep mode to active mode.

In one embodiment, a Control Vector (CV) can be replenished in a periodic one millisecond epoch plus an automatic setup period whose period should be less than a second millisecond. Although, in some embodiments, an epoch can be shortened by using more bandwidth applied to CVs. One millisecond may sound short compared to the time to store data in a packet from a serial data source such as real-time conferencing, VOIP and LTE epochs. In one embodiment, a limiting element of latency can be a propagation delay. In some embodiments, a SAIN network does not need packet buffers, which may result in less congested, or no congestion, within a network as long there is enough bandwidth for sending an aggregation of packets simultaneously during an epoch. Continuing in these embodiments, the result is one-hop connectivity with very low latency.

In one embodiment, two-way verification of a CV to set up a connection not used previously or a connection that was used a long period time ago (e.g., 3 days or one year) may occur only infrequently. Some embodiments of connection setup can use error correction of a CV. Illustratively, the expected BER of a 500 Gbps optical trunk can be between 10̂-15 and 10̂-30. In some embodiments, a higher error rate of greater than 10̂-10 may lead to decommissioning of a particular optical trunk. In some embodiments, short CVs are likely to exist in Layer 1 aggregations in many cases. In these embodiments, the length of such a CV could reduce the likelihood of a critical error by one or two orders of magnitude, as compared to current packet-based methods.

In some embodiments, CVs can be based on local one-hop addressing where the ordinal location of a connection in a Connection Domain supports a physical connection. Parameters of a CV can include data rate for a packet, data rate for a packet flow, and packet lengths after having removed packet headers. Illustratively, removing packet lengths can enhance security or avoid the disadvantages of insecure methods found in TCP/IP networks.

From a logical perspective, there can be virtual Level 2 aggregations of Path Level 1 aggregations between any two E-Nodes in a global SAIN network. In one embodiment, these can become active only when there is one or more Level 1 data flows between an E-Node pair. For example, the amount of effort to make an aggregation real (e.g., active) may take milliseconds in a well-defined network. Continuing in this example, this can includes pairing E-Nodes that exist in different X-Nodes.

In various embodiments, once a connection is set up, a connection can be memorialized into being a virtual connection that can be placed in an ‘on’ state from an ‘off’ state. Once in an ‘on’ state, a connection can be in either an active or a sleep state. User data connections can be forwarded in a Level 1 aggregation over a one-hop circuit. In one embodiment, the number of connections can be limited by the trunk bandwidth (e.g., an optical trunk) and/or an arbitrary maximum number of cellets in a frame. SAIN source and destination Sswitches can be built as addressable switch modules. Whatever the range of input data rates is in a single epoch, the total amount of bandwidth is known as a CV is setup so that the number of modules required can be known and can be known in that period.

In some embodiments, the Sswitchs can use a 4:1 ratio or a 3:1 ratio. For example, three virtual circuits can be in a sleep state for every active state circuit. The three virtual circuits in the sleep state may consume no data channel bandwidth. In one embodiment, the three virtual circuits may consume a one bit per periodic epoch in a CV. Comparatively to an active connection, this can be a small bandwidth.

In some embodiments of a SAIN network, the bandwidth for a large number of active connections (e.g., 1000) can be contained in a single Layer 2 aggregation. The aggregation's plurality of circuits can be in a single route or divided into multiple routes between a single source and a destination. In one embodiment, the Law of Large Numbers may apply before reaching such a large number of active connections (e.g., 1001). As one example, setting up and tearing down (including either into a sleep state or an ‘off’ state) connections can occur in one or two milliseconds.

The number of Layer 2 aggregations can depend on the number of destination E-Nodes that have disjoint connections to a source E-Node. For example, if there are 40 destination E-Nodes, there are also 40 source E-Nodes, each of which connects to the 40 destination E-Nodes. In other words, for a cluster of 40 EC-Nodes to a T-Node, there are 40×40=1600 source E-Node to destination E-Node connections. In another example, if there is an average of 100 connections (i.e., 100,000 connections per second) for each E-Node pair. and if each connection sends a 5,000-bit frame, the total bandwidth for each source E-Node to destination E-Node connection would be 500 Mbps, which would result in each E-Node in a cluster sending 40×500=2 Gbps. Accordingly, in this example, the total bandwidth for a cluster is 40×2=80 Gbps. Continuing further in this example, if there are 20 T-Nodes in a network, the total bandwidth can be 1.6 Tbps. In various embodiments, this may result in no packet congestion. The total bandwidth of a network can depend on the number of E-Nodes. The number of T-Nodes can be to diversify physically network forwarding objects for reliability and survivability.

In many data centers, connectivity bandwidth is oversubscribed by a factor of 4 times the data rate that may be required for a single connection. In various embodiments of a SAIN network, the total connectivity is not based on oversubscription. Instead, connectivity can be maintained with virtual connections in a sleep mode—in order to place them from virtual mode to an active mode, on demand in a short time period (e.g., a couple of milliseconds). In another example, a factor of nine sleep mode connections for each active connection would bring the total available connections to 1,000 instead of 100. In this example, total trunk bandwidth capacity between T-Nodes may limit the real-world upper limit of activity/bandwidth.

In various embodiments, E-Node Ports, E-Nodes (with or without VE-Nodes), and T-Node in each X-Node can use IPv6 addressing. For example, a possible numbering plan can provide 16 bits to define the maximum number of ports with NICs connected to an E-Node and 16 bits for each T-Node|E-Node pair, divided as necessary on a case-by-case basis between the two. Another 16 bits can be for the number of data sources and data sinks for each E-Node. Continuing in this example, this would leave an additional 16 bits for other purposes.

### Using Disjoint Addresses to Locate Network Objects

One of the functions of a communication network, such as, for example the Internet is to forward data from a source to a destination (also referred to herein as sink). The way in which data is forwarded in many current communication networks including the Internet can be complex. This application contemplates a novel network architecture (referred to for convenience herein as “Xnet”) that provides a simple way to forward data from a source to a destination while providing a low-latency, robust, efficient, secure and scalable solution. The Xnet is a data forwarding network that is configured to achieve various network functions using novel networking standards that may be different from the networking standards that currently exist. Many features of the Xnet can be similar to the Synchronized Adaptive Infrastructure (SAIN) networks that are discussed above.

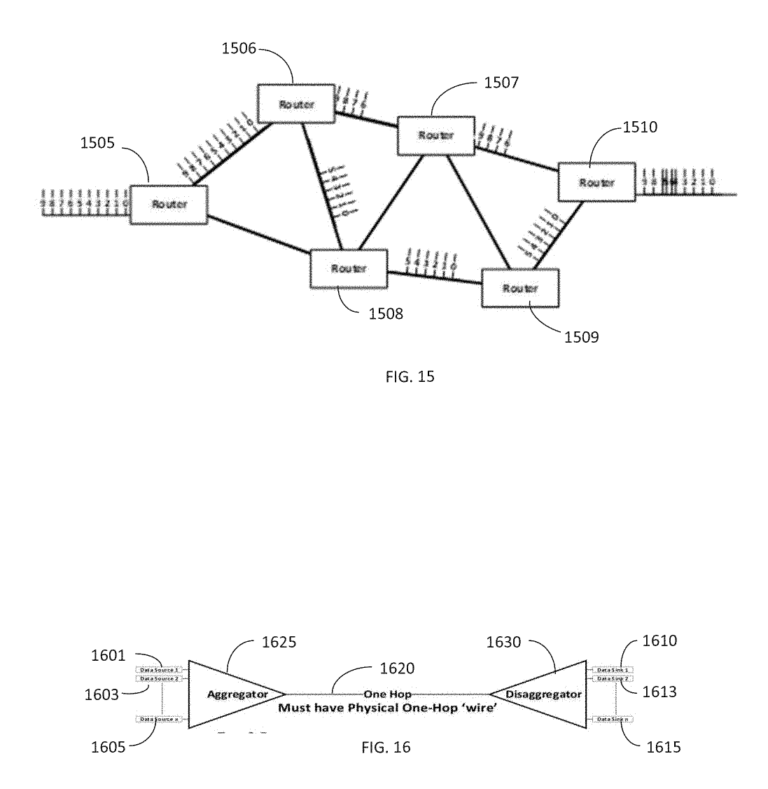

FIG. 15 illustrates an example of a network comprising routing and out-of-order delivery. The network illustrated in FIG. 15 can be a packet network that is similar to the architecture of today's Internet. In FIG. 15, the source traffic comprising a plurality of packets at a first router 1505 is transferred through the network by multiple routers 1506, 1507, 1508, 1509 to a destination router 1510. The path along which the individual packets are forwarded is determined at each router. The plurality of packets can be stored (or buffered) at each router 1505-1509 before being forwarded to the next router. The example network illustrated in FIG. 15 can be referred to as a multi-hop network in which individual packets are forwarded from a source to a destination in multiple hops. The multi-hop network can be complex and/or inefficient.

In Xnet, source to sink data connections are aggregated and are forwarded over a single hop instead of multiple hops. This is accomplished by dynamically and deterministically allocating bandwidth for each connection along the entire path from a source to a sink before any flow begins.

The Xnet can comprise one or more switches that can utilize a pseudo-synchronous clocked algorithm to allocate bandwidth. The Xnet contemplates establishing a separate pipelined flow between a source and a destination of the Xnet. FIG. 16 illustrates an example of a single hop network which is representative of the Xnet. In the single hop network illustrates in FIG. 16, a plurality of data sources 1601, 1603 and 1605 are connected to a plurality of data sinks 1610, 1613 and 1615 by a communication link 1620. The communication link 1620 can comprise a wire, a coaxial cable, an optical fiber or combinations thereof. Data from the plurality of sources can be aggregated by an aggregator 1625 and transmitted over the communication link 1620 to a deaggregator (also referred to as a disaggregator) 1630. The deaggregator can forward the data from each of the plurality of sources to the desired sink (or destination). The Xnet can use out-of-band control for each connection between a source and a destination. The Xnet can be configured to transparently forward data of a serial protocol of any scale as connections between a source and a destination Network Interface Controller (NIC) or equivalent pairs.

A NIC contains both a source NIC (sNIC) and a destination (dNIC). A burst of packets can become a smooth connection that lasts for the duration between the current burst and the next burst in a packet flow. Up packet flow can connect forwarding data from an sNIC in one location to a dNIC in another. An sNIC can forward data over a single-hop (e.g., one-hop) connection to the dNIC. The connection can appear to be wired between an sNIC and a dNIC whether it is or, more likely, is not. Xnet forwarding aggregation-disaggregation of a plurality of connections can make each connection appear to be single-hop.

The Xnet can be both scalable and agnostic. Each forwarding connection from a source node to a destination node is virtual. A possible forwarding connection can exist permanently in a definition inactive mode that is not active. In an active mode, a connection can pass along with other connections through one or more aggregation-disaggregation pairs. For purposes of this application, a “connection” is a generic term and an “Fconnection” is a single data connection forwarding along with other Fconnections through an aggregation-disaggregation node in the Xnet.

The Xnet can be configured as a low latency network. The Xnet can advantageously provide network privacy, network security, availability and/or survivability. In addition, the Xnet can be configured to provide scalability as well as routing functionality. The connections of the Xnet can be virtual, disjoint, simple and deterministic.

The Xnet can be considered to change data from a defined data form to a smooth data stream. An sNIC and its interface to the Xnet can change a defined data form such as a data packet into a short data stream of small nibbles of data called cellets. A cellet can comprise one or more bits of data depending on the data rate of a connection. Small cellets and high aggregation data rates can lower data latency moving through an Xnet. Latency may be reduced to the order of nano- or even pico-seconds.

In present Internet communication networks, a data stream is a burst of packets and can often require substantial buffering as a part of a longer data stream such as an audio and/or a video program. The Xnet contemplates smoothing out a bursty data stream to provide just-enough bandwidth. This can advantageously reduce the amount of buffering and/or result in smooth audio and/or video streams without packet burstiness or large lengthening-of-latency buffers. A dNIC and its Xnet interface can forward data streams as smoothed non-bursty stream of packets to a data sink through very low latency forwarding aggregators.

The current Internet communication networks provide a method of overcoming packet congestions in large packet traffic at very high data-rate bursts. The existing method uses telephone standard circuit switching methods to overcome packet buffer congestion. Such methods may not work well at portions of the network that operate at lower data rates. In such communication networks, complicated and resource intensive systems and methods are used to smooth out traffic burstiness. The result can be a significant amount of hop-by-hop routing in a classical subnetwork that is outside the core network where large amounts of data are aggregated. In heavy traffic, hop-by-hop routing employs packet buffers to smooth out traffic; this can often result in high delay buffer congestion, and packet loss. The result of the combination of large aggregations and multihop routing can decrease efficiency and/or increase latency. The Xnet contemplates solutions to increase efficiency and/or reduce latency especially in regions of communication networks that operate at low data rates and/or data with small packet sizes.

The Xnet can overcome latency and burstiness problems of existing Internet communication networks without using methods such as tunneling or overprovisioning. The Xnet network architecture can increase efficiency and reduce latency by methods such as deterministic dynamic allocation of bandwidth. Deterministic dynamic allocation of bandwidth can provide effective use of large traffic aggregations resulting from the Law of Large Numbers being applicable throughout the network. Xnet traffic can concomitantly include both stored and real-time traffic sources. The outcome can combine low latency with efficient use of bandwidth. It can also provide an effective use of large traffic aggregations. Such traffic can concomitantly include both stored and real-time traffic sources.

The Xnet is an agnostic network below the conventional IOS Layer 2 or other serial data protocol. A plurality of connections at a source can combine into an aggregation of connections from a source node to a destination node. All NICs connect in pairs. A NIC pair can be programmed to support a connection of an extant data protocol supported by the NICs' processors. A combination of an sNIC and a source Xnet node can change data from packet form into a stream of bits forwarded through a given connection. A dNIC and a destination Xnet node can change the stream of bits from the connection into packet form data for delivery to a user. The protocols to be carried depend on those supported by each NIC pair. There may be no limits to the number or utility of protocols that can be carried as long as the NICs are able to support.

Each connection of a sNIC-dNIC pair is disjoint from all other connections in an aggregation and between aggregations. For example, an sNIC-dNIC IPv4 pair can be disjoint from an sNIC-dNIC IPv6 pair. An Xnet can forward a plurality of sNIC-dNIC pairs in an aggregation regardless of each pair's input-output data protocols. For example, many NIC pairs can support Ethernet protocols. At the same time, a single pair of NICs can have a protocol that is compatible only between the two NICs.

A NIC pair can be a unicast single sNIC connected to a single dNIC. In addition, it can be configurable into multicast connections where a single sNIC connects to a plurality of dNICs. An Xnet can vary in size and application from small to global network size. There is no logical or theoretical limit to size; physical limits can include clock rates and bandwidth of each data trunk.

In current Internet communication networks, five main protocol layers are used to forward Internet network packets. The various protocol layers include (i) a physical layer, that includes the hardware systems, components and/or devices that form the basis of the communication network, (ii) a Link layer, (iii) an Internet layer, (iv) a Transport layer, and (v) an Application layer. In previous generations, all layers except the physical layer depended on asynchronous connectivity with stochastic behavior. This was an appropriate way to design a network under the assumptions made during the late 1970's and on into the early 1980's and that has been the Internet way since. In Xnet, the various layers need not depend on asynchronous connectivity with stochastic behavior.

In the 1970's-'80's period, the Physical layer approaches depended largely on Telephone Company (TELCO) circuit switch methods. TELCO network circuit switching standards have always used fixed industry-standard parameters including fixed data and trunk connection bandwidths, fixed data frame sizes, fixed data frame rates, and fixed data aggregation sizes.

AT&T and other international voice-centric research and network operational organizations joined with government- and industry-supported standards groups. Among their activities was choosing specific values of all fixed parameters. Values chosen supported voice transmission with no direct support of data networking other than using the voice network standards as bearer channels for data.

Tunneling standards for Internet connectivity became necessary in the 1990's in order to try to emulate end-to-end circuit connectivity for Virtual Private Networking and other services. The use of tunneling has proliferated into many areas each of which results in complexity involving both Layer 2 and often Layer 3. In essence, tunneling tries to emulate circuit switching in an asynchronous network. But a circuit-based foundation with dynamic parameters can be simple.

During the first conceptions of an Internet, circuit switching was not considered to be a part of networking packets. However, as the amount of data generated started to increase exponentially, systems and methods that increased router capacity that did not rely on forwarding data on a per packet basis were considered. One of the proposed solution was to consider circuit switching at high data rates which was used by various TELCOs to handle large traffic volumes. Lasers and other optical systems were also employed to increase data capacity. Committees for various standards decided to focus on fixed data rate that included 1.0 Gbps, 10 Gbps, and 100 Gbps. There are some intermediate data rates, but following after Ethernet's approach, factors of 10 seemed to be a good idea.

However, most network architectures employ “circuit switching” for only for large aggregations of packets. One reason for employing “circuit switching” for large aggregations of packets only can be attributed to the belief that “circuit switching” is efficient for fixed standardized parameter values. In contrast to conventional thinking, the Xnet architecture employs dynamically changing bandwidth of a circuit switched path to efficiently route individual packets and/or small aggregates of packets. Thus, the Xnet is based on the notion that circuit switching can be employed without required fixed standardized parameter values. The Xnet employs systems, methods and/or algorithms that can change the bandwidth of any circuit switch connection very quickly.

The Xnet approach to overcome the complexity of the various Internet layers begins with replacing the idea of fixed parameter standards with a synchronized yet flexible variable parameter structure. The new structure can use dynamic bandwidth control and a new security approach. The structure focuses on simplicity and deterministic (instead of stochastic) performance while supporting rapidly changing basic parameters. In addition, Xnet can place routing and load balancing along with dynamic bandwidth management and security as fundamental data-plane capabilities. These capabilities are manageable by control-plane software, e.g., assuring links for the network have enough bandwidth.

As an example, the result can be a much better Software Defined Networking (SDN) design than can exist with its current stochastic approaches with fixed parameters. The Xnet architecture focuses on simplicity and deterministic performance while being able to change basic parameter values rapidly. An Xnet-based SDN can provide robust management of large networks with much simpler capability and improved latency. Robust security and privacy does not require encryption methods. In addition, the Xnet structure can comprise disjoint network forwarding objects.

### Using IPv6 Addressing for Xnet-Systems and Methods of Global, Private and Local Addresses for Xnet Objects

IPv6 addresses can be a basis for setting up a set of capabilities of an Xnet network. Methods of identifying the locations of source and sink connections in an Xnet can further enhance the capability of an Xnet. This can be advantageous in at least in two ways. One is to provide global and private addresses for Xnet objects. The other is to support a method of building a database that can show the location of various objects and their pairs in real time. The latter can be important as the number of mobile devices connecting to the Internet will continue to grow exponentially.

The fundamental Xnet network architecture or structure can place entry node (E Node) connectivity as a part of the network. In one implementation, Xnet can require each source E-Node (sE Node) in a first network to be capable of connecting to every destination E-Node (dE Node) in the first network or a different network connected to the first network directly or indirectly. Each E Node is given an IPv6 name that can include a 64-bit network name for the total network plus individual 64-bit E Node names (for both the sE Node and the dE Node of each E Node). Attached to each E Node is an address that can include information about connectivity to its dE Node from any sE Node in the network. The 64-bit width is an example and not a limitation. Other bit widths, e.g., 32 bits, 128 bits, etc., may be used.

In some implementations, each E Node can connect to a cluster of data sources in an sE Node and a data sink in a dE Node. An sE Node may not connect directly to a dE Node. Direct connection may occur if the data source and data sink connect to the same E Node, e.g., the sE Node to the dE Node connected through a source Transit Node (sT Node) where the sE Node can be an object in a cluster of sE Nodes. A sT Node can have a plurality of input connections. Various examples of input connections are provided in FIG. 26 of U.S. Pat. No. 8,635,347, which is incorporated by reference herein for all that it teaches. Another attribute of the Xnet structure is that its Path Level 1 can connect to more than one parent T Node through an sE Node or a dE Node to more than one T Node. Optical connectivity can be one possibility with low-cost transceivers.

Properties of a Control Vector (CV) are described in detail above as well as in U.S. Pat. No. 8,635,347 which is incorporated by reference herein in its entirety. The CV can be configured to control the properties of a source X switch to destination X switch (sXswitch-dXswitch) pair. A CV may exist only at an sXswitch or at a dXswitch. A source Control Vector to destination Control Victor (sCV-dCV) and sXswitch-dXswitch connectivity can occur between the same source and destination nodes, but they may travel over different routes. In addition, multiple possible routes for each sT Node-dT Node pair may exist.

A CV controlling the properties of an sXswitch-dXswitch pair may have a single purpose and no other purpose. A sCV-dCV and sXswitch-dXswitch connectivity can occur between the same source and destination nodes, but the connections can travel over different routes.

### Dividing a Regional Internet Registry (RIR) Path Aggregation-Disaggregation

Much of Internet control conforms to Internet Engineering Task Force (IETF) Requests for Comments (RFCs) that contain many fixed parameters of the bits used in a protocol. The implementations of Xnet contemplated in this application can comprise only a few fixed parameters. One or more parameters of the Xnet (e.g., bandwidth allocation) can be flexible thereby providing bandwidth and cost savings. The various implementations of the Xnet can greatly simplify the Internet world by 1) improving performance within the confines of existing infrastructure; and 2) serving as the foundation of a brand-new infrastructure.

In an implementations of the Xnet, a single Regional Internet Registry (RIR) number is capable of defining 2⁶⁴=1.844674×10¹⁹ items. This number can be larger than the number of device IDs that may be required in an Xnet numbering plan. There can be a simple way to define fixed number of connection parameters of Path Aggregation-Disaggregation Switches, T Node, E Node, and Path Level 1. For example, the 64 bits in an RIR can divide by 4 to 16 bits for each maximum number of connections. There may not be a need for a global fixed number for the four quantities—Path Aggregation-Disaggregation Switches, T Node, E Node, and Path Level 1. Dynamically allocating resources can advantageously save bandwidth; and reduce error rate due to noise (e.g., if the bandwidth used is reduced by a factor of two, the error rate due to noise is reduced by a factor of two as well).

Various factors can be taken into consideration when designing communication networks including but not limited how many bits should be used to define various Path Level 1, how many NICs are assigned per E-node, should the number of NICs increase linearly or exponentially as Path Level 1 value increases, what should the step size be for increasing the number of NICs, etc.

As an example, Table 1 below shows 32 Path Level 1, i.e. 5-bit values. The first 9 values are linear followed by exponential values with a ratio 9/8, i.e. 1.25. Assumed are ‘0’ 1,000 NICs per E Node. If the network has a million E Nodes, the number of NICs would be 1.0 to 135,130 billion NICs in the network.

TABLE 1
Table 1: 32 Path Level 1 values

| | |
|---|---|
| 0 | 1000 |
| 1 | 2,000 |
| 2 | 3,000 |
| 3 | 4,000 |
| 4 | 5,000 |
| 5 | 6,000 |
| 6 | 7,000 |
| 7 | 8,000 |
| 8 | 9,000 |
| 9 | 10,125 |
| 10 | 11,391 |
| 11 | 12,814 |
| 12 | 14,416 |
| 13 | 16,218 |
| 14 | 18,246 |
| 15 | 20,526 |
| 16 | 23,092 |
| 17 | 25,979 |
| 18 | 29,226 |
| 19 | 32,879 |
| 20 | 36,989 |
| 21 | 41,613 |
| 22 | 46,814 |
| 23 | 52,666 |
| 24 | 59,249 |
| 25 | 66,655 |
| 26 | 74,987 |
| 27 | 84,361 |
| 28 | 94,906 |
| 29 | 106,769 |
| 30 | 120,115 |
| 31 | 135,130 |

Each Control Vector that defines parameters for synchronizing the values of switch parameters can involve a single sXswitch-dXswitch pair. The values can change to fit dynamic traffic loads on the switches. The numbers of open connections can change depending on the nature of the load. For example, a video data stream may send data frames in bursts resulting in the system's ingress packet buffers not smoothing frames into a steady stream. In cases like this, it can be necessary to leave a connection in a sleep mode. A connection can be in a sleep state of a real connection (as opposed to a virtual one) and maintain a connection number and location in a Connection Domain even though there is no bandwidth used in the frame.

### Examples of how Xnet Technology can Update Existing Internet Implementations

a. Synchrony in the Internet

Synchrony among network objects is a special service in the current Internet that can use protocols such as the IEEE 1588 standard. Xnet connection can include synchronization of nodes. An Xnet can use plesiochronous connectivity between node pairs as described in U.S. Pat. No. 9,137,201, which is incorporated by reference herein in its entirety for all that it teaches.

b. Supporting Both IPv4 and IPv6 Connections

At Internet Layer 3 protocol, IPv4 sNIC-dNIC pairs and IPv6 sNIC-dNIC pairs can exist. Both IPv4 and IPv6 connections can forward over a single Xnet route. There may not be any need to use existing protocols to employ encapsulating IPv4 connections into IPv6, or vice versa.

c. Replacing Tunnels and Other Internet Circuit Emulation with Xnet Technology

During an upgrade to the Xnet, it may be necessary to update NIC pairs. But using the Xnet and replacing existing NIC pair connections can occur without major problems.

### An Example Implementation of the Xnet

In a global Xnet, there can be five main levels of aggregation. The highest level can be a mesh network of eXchange Nodes (X Nodes). Each X Node can connect to every other X Node in a global network. This can use aggregation methods with or without higher-level aggregation nodes than X Nodes.

Each X Node can be a parent of a plurality of Transit Nodes (T Nodes). Like an X Node, each T Node can connect to every T Node whose share an X-node as a parent. Connections among the T Nodes can make use of a novel routing algorithm that is capable of computing either possible loop-free routes among the T Nodes or loop-free routes up to a given maximum number of serial link connections. Both the available bandwidth of every node along with its end-to-end latency can be available to a source T Node of a route. These parameters can be available periodically, e.g., once per 1 ms, 5 ms, 10 ms, etc., and can be configured to not burden the network and not increase the latency.

Each T Node can be a parent of a cluster of E Nodes. Each E Node can connect to every other E Node in an Xnet. Connections between two E-Nodes can be virtual. The way in which a virtual connection can become real is discussed below.

### Exemplary Methods

The present application discloses methods that enable a further reach into larger networks. The methods disclosed herein can show ways to replace a multi-network control and other topics with deterministic methods made possible by Xnet technology.

The present application discloses methods that overcome the complexities of setting up end-to-end simulated circuits in the current Internet. The Xnet methods can: 1) provide end-to-end one-hop connectivity of current and future Ethernet and IP protocol connections; and 2) upgrade much of the Internet's complexities and performance difficulties, e.g., in end-to-end latency and internal network packet-buffer-congestion, in security and privacy, public and private networking, etc. Xnet routing methods can assure all E Node to E Node connectivity can exist in both a virtual as well as active state.

This application can apply to an underlay network either to forward: 1) a plurality of single connections; or 2) a plurality of aggregation connections.

### Method of Addressing NICs and Other Objects.

The structure of an embodiment of Xnet can facilitate an addressing system for large-scale networks. It can be different and easier to scale with one-hop forwarding. All inputs and outputs can connect to E Nodes. In public or large private networks, an embodiment of Xnet can enable every E Node in a network to connect to every other E Node.

All outside data sources and sinks can connect to E Node either directly or indirectly. Each E Node can have two sub nodes—one for connecting a data source to an sE Node (source E Node), and one for connecting a data sink to a dE Node (destination E Node). All NIC and other objects involved with data forwarding can be given an address for the Xnet. It can be a mix of IPv6 and IPv4 turned into IPv6 protocols.

The following may be applicable to an embodiment of Xnet: (i) each source data source can connect to an sE Node, (ii) Each data sink can connect to a dE Node, any data source can connect to an sE Node, and a dE Node can connect to a data sink, (iii) each data source can be assigned an IPv6-IPv4 identifier (IPv6 ID) that can be based on the Extended Unique Identifier (EUI) of the IEEE, (iv) every IPv6 ID data source and data sink can connect to an sE Node and a dE Node, (v) each IPv6 ID can connect the entry point of data from data sources and sinks, (vi) each E Node can have an IPv6 ID address that can be a class of object separate from NIC IPv6 IDs.

All information about an IPv6 ID source and sink object can be available in the object's E Node. The IPv6 ID for an E Node can be used as a destination or source address. Sources and sinks may be mobile (e.g., portable, wireless, movable, etc.). The Xnet address system can deal with that aspect by building large databases with IPv6 IDs. Table 2 and Table 3 below illustrate examples of addressing NICs and other objects in the Xnet. The databases can be stored at various parts of a large network and be available to users, e.g., those with mobile data sources and/or sinks. An E Node can keep data in stored databases. There are a number of data items that can be included, some of which are in this document. Updating user mobile locations can take a short time, e.g., less than 0.5 to 1.5 second. An implementation can get mobile user data sources and sinks in a very short time. This can be important to wireless networks.

Table 2 lists the location of eu-64 NIC addresses in an X Node domain of an Xnet. Table 2 shows how a list of locations, i.e., E Node addresses, can appear. If there are more than one X Node in the list, it may be necessary to show three names (numbers) X:T:E. If there is only one X Node, there may be no reason to send repeatedly the X-Node number. It can be sent once, and the rest will be --:T:E: as is shown in Table 3. The NIC Status column shows whether the NIC is active or not. If a NIC address is active, a row contains a ‘1’. If that NIC is inactive for any reason, a row contains a ‘0’. There may be other numbers that can show the reason for the ‘0’.

Dealing with a Large Number of NICs in EUI-64 Tables

A source for associating the address of a NIC to its parent E Node can be the E Node itself. For example, a new NIC connecting to an E Node can cause a CV message to one or more tables that can exist within a network with a plurality of EUI 64 labels as designed by the IEEE.

TABLE 2
E NODE PARENTS OF NIC EUI 64
ADDRESSES IN NUMERIC ORDER

| NIC | X_{NET} X:T:E | NIC |
|---|---|---|
| EUI-128 Address | E-Node Address | Status |
| 391F:AC56:413B:DFAE | —:3:5:23 | 1 |
| 4A33:16FA:6077:8E11 | —:8:5:23 | 1 |
| B5C0:1339:A3D2:8600 | —:3:5:18 | 0 |
| — | | |
| NIC | X_{NET} X:T:E | NIC |
| EUI-128 address | E-Node Address | Status |
| 9415:3466:5BD4:10BA | —:5:18 | 1 |
| 9416:C0:FFFE:69:A8D1 | —:3:8 | 1 |
| C24E:A3:FFFE:72:E175 | —:15:22 | 0 |
| — | — | — |

Table 3 shows an example of a table that can show the EUI 64 label of each NIC that connects to its parent. The table sorts the EUI 64s in number order. A table that combines all tables connected to E Nodes whose parent is a T Node can connect to the T Node (not shown). The EUI 64 tables attached to each T Node can become a single table that contains, in numeric order, all NIC EUI 64s in an X Node domain.

TABLE 3
A LIST OF NICS THAT CONNECT TO
E NODE #18 OF PARENT T-NODE #5
X_{NET} sE-Node Address: —:5:18

| sNIC | sNIC | |
|---|---|---|
| EUI-64 address | Status | sRecords |
| 15:C3:33:7E | 1 | Connected to E-Node at 150828:0825 |
| 94:66:D4:BA | 1 | Connected to E-Node at 150609:0825 |
| FE:72:2A:75 | 0 | Disconnected from E-Node at 150903:0432 |
| — | — | — |

The databases can contain NIC addresses of the E Nodes to which a data source and a data sink connects. A source address of an sNIC can define the sE Node to which the sNIC connects. The sE Node address can contain a table with the location of the sNIC in the cluster of sNICs attached to the sE Node. A route from a plurality of routes can be chosen by the parent sT Node of the sE Node that connects to the dT Node that is the parent of the dE Node, which in turn is the parent of the dNIC in the dE Node's cluster of dNICs.

The sE Node's sT Node parent can find the best available route to the dT Node. If the dE Node's parent T Node is the same as the sE Node, then no route is required. Only a connection in the sT Node to the dT Node is required.

The periodic updating of the large databases may include changes of locations of sources and destinations, e.g., a change of NIC parent addresses. A local change such as changing the port connection of a NIC can be handled by the parent E Node.

The systems and methods described herein can be used as Link Layer 2 connections. The described systems and methods can be much simpler than the existing Ethernet protocol.

A Method of Finding a Location of any NIC within an X-Node Domain

This application contemplates new ways of finding the location of any NIC or NIC like object in an Xnet from its address. A location is usually the physical location of a parent connection of either a single NIC or a plurality of NICs in an aggregation. The lowest level of aggregation in a NIC-based network is Path Level 1.

The described systems and methods can be useful to connect sNICs to dNICs in both public and private networks. A Level 2 Aggregation can be the aggregation level of choice to forward sNIC to dNIC in either a private or a public network. To accomplish this, a sE Node can connect to a dE Node in a private network or public network. Connecting a sE Node in a public network to a dE Node in a private network or connecting an sE Node in a private network to a dE Node in a public network can require special protocols and handling to assure security and privacy, e.g., as described in U.S. Pat. No. 8,635,347 which is incorporated by reference herein in its entirety, and U.S. Pat. No. 9,137,201 which is incorporated by reference herein in its entirety.

### Xnet Components for Use of the Application's Methods

The Xnet components for use in this application can include two types. One is for implementing a new method for addressing and/or locating a NIC; the other is for implementing switching, aggregating-and-disaggregating, forwarding and selecting best practical routes in high-performance flows. Possible routes can be computed prior to use. Compared to the current Internet, the Xnet can have 1) less bandwidth required to achieve packet flow excellence, e.g., Quality of Service (QoS), and 2) lower real-time startup flow latency, rather than building extended buffer delay ahead of screen presentation for stored traffic such as videos. Current network extended buffer delays may be good for stored data flow startups, but it is not useful for either real-time broadcasting or, even more so, for real-time interactive connections. The Xnet can have the advantage of using large aggregations of traffic making the use of the Law of Large Numbers. For example, suppose that a partition of a network involves 25 sE Nodes in a cluster whose parent is an sT Node that passes an aggregation to a dT Node with 27 dE Node children. Each of the 25 sE Nodes in the sT Node cluster connects to each of the 27 dE Nodes in the dT Node cluster. The total number of connections between the two clusters is 25×27=675 user connections. Assuming that the average number of user connections is 8, the total number of connections is 5,400. If a burst is 20 times an average flow-rate the change in the aggregation is 20/5400=0.0037. In other words, it is 0.37% of the average flow rate of the aggregation. It is small relative to the total bandwidth.

### Packet Handling as a One-Hop Process

Packet handling in the Xnet is a one-hop flow process from a source sNIC connected to a defined physical location of an sE Node to a matching dNIC. The dNIC can connect either to: 1) a dE Node in the same E Node as the sE Node; or 2) a dE Node in an E Node at another physical location. The expected distance between the sE Node and dE Node can equal the sum of the link distances nominally between a combination of Level 2 and Level 3 forwarding nodes. These distances can be easily measured and compared to a priori values. Temperature changes of the measured length of physical non-wireless transmission links may vary in proportion to total transmission length and temperature degree changes along the path. Comparing the round-trip Control Vector values with round-trip of data path connections can be a good method of assuring the validity of the measurements for security purposes.

Very Large Number of sNIC-dNIC Connections can Result in Using Sublevel Path Level 1 Aggregations

In the case where the number of NIC to E Node connections is very large, it may be good practice to add another level—a sublevel of Path Level 1. The sublevel may involve defining the NICs as a cluster of physical areas that each contains NICs. The areas may be parts of a cluster per E Node. Each can provide a more accurate link measurement from sNIC to dNIC.

### Path Level 1 Aggregations Provide a One-Hop E Node to E Node Connectivity

A Path Level 1 sXswitch can aggregate all data connections from a single sE Node to a plurality of dE Nodes in a network partition up to an entire network. There can be four different structural ways that the network can connect to a dE Node. Some possible are described in U.S. Pat. No. 8,635,347 which is incorporated by reference herein in its entirety, and U.S. Pat. No. 9,137,201 which is incorporated by reference herein in its entirety.

Forwarding Level 2 Aggregations Interconnecting One sE Node to a dE Node with a Matching Cluster

For a cluster of E Nodes, an sE Node can forward all Path Level 1 aggregations that exist from the sE Node to each dE Node with a cluster. An sXswitch for each sE Node can contain a plurality of the Path Level 1 aggregations, each of which connects to an aggregation for disaggregation of a dXswitch in each dE Node of the cluster. This method can implement the Crossconnect function in a parent T Node of the sE Nodes.

To reach all other E Node clusters in a network, the same method can obtain for active sE Nodes in a network connecting to its parent T Node as an sT Node whose dT Node connects through a routed connection to an sT Node of every other T Node in a network.

### How the Future of Networking can Become as Simple as the Distant Past

If the future of networking were like the distant past, it would be relatively simple to set up networks. For example, each telephone required a fixed physical address and had a given telephone number. Wires connected telephones to switches in central offices. Today's network is very different. Each physical object in a network is given a unique number or other name, but more and more connections are wireless or are tied to data centers that connect physical devices to servers and storage as well as to each other.

In the 1970's, the result focused on a seven-layer network structure that in some situations remain today. Primarily, however, networking has morphed into a five-level Internet and more and more connections are becoming wireless at the expense of wired user connections. So far, wireless communication is limited in bandwidth compared to optical fiber. Combining wireless with optical aggregation connections can be an ideal combination of a network that fits well with the Xnet architecture.

### The Role of Proper Nomenclature

Proper nomenclature is a foundation of good mathematics. It is also a foundation of good networking. A two-point connection is a foundation of networking. In all cases, multiple point-to-point connections can still be the foundation of any multiple of source to destination connections.

From a nomenclature point of view, either a source or a destination is always a single location in a network. A one-to-many configuration can be a single source to many destinations. A many-to-one is many sources to a single destination. A many-to-many relationship deals with multiple types of sources and destinations each of which can be one-to-many and many-to-one connections. In other words, single source-to-many destinations and many sources-to-single destination might occur in various configurations. A good example of many-to-many applications are publications that deliver both to a plurality of users and each of plurality of users who can chose particular section(s) of a publication.

### Method of Finding E Node (or Other Aggregation Level) Locations of Source and Destination NICs

The Xnet can use Media Access Control (MAC) or Extended Unique Identifier (EUI 64) labels approach for finding E Node locations of source and destination NICs. Media Access Control (MAC) addresses appeared with an OSI Layer 2 for the Ethernet protocol. A group of addresses denotes a specific vendor who furnishes Ethernet-forwarding packet products. The packet possesses a destination address followed by a source address and a few other parameters. The purpose of the first Ethernet products is to carry a packet that is at least 64 bytes long and carries up to a 1,500-byte payload. For example, an IEEE standards group now defines larger maximum size payloads. An EUI 64 can include what was a MAC address, but also can extend into areas other than networking.

Implementing Global Xnets and Xnet Subnets with IPv6 Addresses

An Xnet global network can be hierarchical. IPv6 values appear to be an excellent way to label each part of the hierarchy as defined by international standards. As a part of IPv6 is the IEEE way of addressing the “interface identifier,” the so-called “Extended User Identifier” (EUI). There may be other choices for a specific Xnet, e.g., in a future installation. This disclosure uses EUIs to label Xnet connectivity objects. This is done by way of example, and not for limitation.

Regardless of the labels assigned to an entire network, there can be another way to achieve good results in Xnet implementations with a Control Vector, e.g., the Power-of-Two values shown in Table 4. The values shown are taken to be for the current highest values. For a given Xnet, the value can be less than or equal to the highest values. Each aggregation in a network can forward its data using a Control Vector.

TABLE 4
Xnets with temporary maximum power
of two addressing of Xswitches

| Y-Node | X-Node | T-Node | E-Node | PL-Node | Total |
|---|---|---|---|---|---|
| 4 | 8 | 5 | 7 | 16 | 40 |

Table 4 shows a possible temporary upper bound set of bandwidth allocations for each aggregation link in a very large network. “Temporary” can quantify the upper bound of a network. As technology changes and enters into the marketplace, the upper bounds may change. Reading the figure from left to right, there are up to 2¹¹=2,048 X-Nodes consisting of 2³=8 very large superregional Y-Node-forwarding-centers, each of which comprises up to 2⁸=256 X-Nodes. The Y-Nodes and X-Nodes together can enable each X-Node to connect to every other X-Node. Likewise, for the combination of 2⁵=32 T-Nodes each of which supports up to 2⁶=64 E Nodes there are up to 2¹¹=2,048 E Nodes. Furthermore, Table 4 shows there are up to 2¹⁶=65,536 NICs connecting to E Nodes. The total can comprise sublevels as disclosed above. Table 4 shows how an Xnet can expand to be a very large entity while providing a simple method of finding the location. An E Node is the parent node with a known location of both source and destination of NIC's connection. The same approach with smaller numbers can also show the figure can exist and quantify a much smaller private network and less expensive technology.

### Method of Use in Control Vectors of the Limit Values Shown in Table 4

Numbers shown in Table 4 can be an upper limit within a large Xnet. They can be subject to update change as a network grows for an entire network. These numbers need not be the values shown in an operational Control Vector (CV). A CV can exist only to manage synchronization of only two tables in a two-point connection, one that appears in an sXswitch and its paired dXswitch. The source location can build a CV based on a standardized structure. For many occasions, having a list of the largest value for relevant entries in a Table 4 list measured in bits can reduce a CV's size. Using the smallest number of bits to define a CV not only saves bandwidth but also minimizes the likelihood of errors. The fact that CVs operate only on two-point connections (even in multipoint connections) is an advantageous aspect of an Xnet.

### Maximum Values of a Private Network

TABLE 5
Xnets with temporary private network addressing of Xswitches

| Y-Node | X-Node | T-Node | E-Node | PL-Node | Total |
|---|---|---|---|---|---|
| 0 | 3 | 5 | 6 | 12 | 26 |

Table 5 shows the maximum values in a Control Vector for an example private network. There are 0 values for a Y Node and an X Node that are built into the installation of the network. There is a maximum of 4 T Nodes and 16 E Nodes per T Node for a maximum of 64 E Nodes. Each E Node contains a maximum of 1,024 NICs per E Node.

### An Example of a Very Large X Node Table

The number of E Nodes in Xnet can be the sum of the number of NICs in each T Node. In a very large network, there can be one or a plurality of Xnet public networks each of which can be a partition of the very large network. In addition to public network(s), a private partition can also be a partition of the same very large Xnet. Private network NICs and network nodes can be invisible, i.e., a private network is disjoint from a public network and all other private networks.

### Method of Allowing Public and Private Networks to Share a Single Very Large Xnet

The fact that each connection in the Xnet of any size can be disjoint from every other connections is advantageous to assure security and privacy of a connection. The basic algorithm of Xnet networking partitions can separate logically each connection from every other connection. Managing the size (i.e. bandwidth) of each connection can use Control Vectors to synchronize a destination table to a source table. A CV can achieve the management function in an out-of-band manner. This can enable sending the CV over a disjoint path. This can apply to both Path Level 1 and higher and lower level aggregations. The chosen path can change from CV epoch to epoch. The systems and methods described in U.S. Pat. No. 2,292,387 by Hedy Kiesler Markey (also known as Hedy Lamarr) with George Antheil, dated Aug. 11, 1942, titled “Secret Communication System” can be used to overcome jamming of radio signals by changing carrier frequencies periodically. The method was important during World War II. Similarly, a version of the method using disjoint paths to carry CVs as well as data paths can be useful. However, there are many more ways of achieving robust security. Some methods to assure security using an interchange between the NIC and other components of the Xnet are described below.

If a NIC discovers an arriving packet to be a first part of a flow, the NIC can discover its header and prepare it to be a part of a CV. In addition, the components of the Xnet can identify an unused connection number in the sXswitch-dXswitch pair and identify each successive packet with the same numeric header. An arrival of a packet at a dNIC can replace the connection number with a header of the original packet. Once there are numbered header packet flows, it is possible for a CV to send a shuffle of the numeric header numbers among the packet flow connections. Shuffling routes on which the CVs travel can be another possible security practice.

If a packet arrives at a NIC with a ‘protocol friendly’ header, i.e., a protocol recognized by a NIC, the length portion of a header is removable from the packet and can be forwarded independently from the rest of the packet over a CV. This can enhance security in a number of ways. If a single packet's length value is a constant known value for a given protocol, an sNIC can add a random number of ‘pad bits’ that can be removed by a paired dNIC. Just a few bits can change not only a single connection, but can also change the positions of many, if not all, other connections. If a packet flow contains fixed lengths such is the case with Ethernet packets for its 1,500 bytes limitation forwarding large files, changing the successive packet lengths by a few bits or bytes can have significant effect on other connections. In the above-identified methods, there are no visible connection boundaries that can be found without having access to an sXswitch-dXswitch pair's Control Vector.

As described in U.S. Pat. No. 8,635,347 which is incorporated by reference herein in its entirety, and U.S. Pat. No. 9,137,201 which is incorporated by reference herein in its entirety, possible routes and their properties for sT Node to dT Node connectivity can be determined prior to use. It is also contemplated that the Xnet has the ability to determine the end-to-end delay of each route and the amount of bandwidth available if there is no traffic in the route. For optical transmission, the end-to-end delay can change slightly because of temperature and other variations.

In another method to enhance security, each NIC may nominally exist at a known distance from a connection to an E Node; each E Node can know the distance of different routes to other E Nodes in a network. A CV can send a random noise sample to either a NIC or another E Node that can cause a fast response with the sample. If the response of the sample occurs at an allocated amount of time, it can be good evidence of the distant NIC or E Node. The source CV can trigger a distant return path to be set up and send in a short burst the noise sample to the return CV source.

Xnet also contemplates using Path Level 1 additions to establish usable sE Node to dE Node Level 2 connections. Routing in the Xnet can include defining virtual connection of one partition of the Xnet with another partition that does not connect directly with the one partition. The methods described herein can be used to set-up up one-hop Ethernet protocol connections between any sNIC-dNIC pair that supports given user IP or other protocols in a global network

### Method of Implementing a Low-Cost, High-Speed Connection Domain/Space-Time Domain Transform Switch

This application contemplates a novel method for applying bandwidth to connections. Such methods can be useful in an aggregation switch of the Xnet. The method can start with two well-known parts. One is a representation of a Connection Domain; the other is Space Time Domain. The two domains deal with frames each of which carry an equal number of cellets. A cellet can comprise one or more bits of data depending on the data rate and system clock rate of a connection. The highest clock rate of a system used to forward cellets plus a one-bit cellet can provide the lowest possible latency of an aggregation that is a Power-of-Two.

The method comprises choosing a power-of-two that is the smallest possible to cover the size of a frame. The frame can be of any size. For example, if the actual length of a frame is 50 then the smallest power-of-two that covers the frame is 6. Accordingly, the method would select a frame that is equal to 64 cellets as shown in Table 6. Thus the frame selected by the method would have 14 empty locations.

TABLE 6
Transform Table

| # | 1 | 2 | 3 | 4 | 5 | 6 |
|---|---|---|---|---|---|---|
| 0 | 0 | 0 | 0 | 0 | 0 | 0 |
| 1 | 1 | 2 | 4 | 8 | 16 | 32 |
| 2 | | 1 | 2 | 4 | 8 | 16 |
| 3 | | 3 | 6 | 12 | 24 | 48 |
| 4 | | | 1 | 2 | 4 | 8 |
| 5 | | | 5 | 10 | 20 | 40 |
| 6 | | | 3 | 6 | 12 | 24 |
| 7 | | | 7 | 14 | 28 | 56 |
| 8 | | | | 1 | 2 | 4 |
| 9 | | | | 9 | 18 | 36 |
| 10 | | | | 5 | 10 | 20 |
| 11 | | | | 13 | 26 | 52 |
| 12 | | | | 3 | 6 | 12 |
| 13 | | | | 11 | 22 | 44 |
| 14 | | | | 7 | 14 | 28 |
| 15 | | | | 15 | 30 | 60 |
| 16 | | | | | 1 | 2 |
| 17 | | | | | 17 | 34 |
| 18 | | | | | 9 | 18 |
| 19 | | | | | 25 | 50 |
| 20 | | | | | 5 | 10 |
| 21 | | | | | 21 | 42 |
| 22 | | | | | 13 | 26 |
| 23 | | | | | 29 | 58 |
| 24 | | | | | 3 | 6 |
| 25 | | | | | 19 | 38 |
| 26 | | | | | 11 | 22 |
| 27 | | | | | 27 | 54 |
| 28 | | | | | 7 | 14 |
| 29 | | | | | 23 | 46 |
| 30 | | | | | 15 | 30 |
| 31 | | | | | 31 | 62 |
| 32 | | | | | | 1 |
| 33 | | | | | | 33 |
| 34 | | | | | | 17 |
| 35 | | | | | | 49 |
| 36 | | | | | | 9 |
| 37 | | | | | | 41 |
| 38 | | | | | | 25 |
| 39 | | | | | | 57 |
| 40 | | | | | | 5 |
| 41 | | | | | | 37 |
| 42 | | | | | | 21 |
| 43 | | | | | | 53 |
| 44 | | | | | | 13 |
| 45 | | | | | | 45 |
| 46 | | | | | | 29 |
| 47 | | | | | | 61 |
| 48 | | | | | | 3 |
| 49 | | | | | | 35 |
| 50 | | | | | | 19 |
| 51 | | | | | | 51 |
| 52 | | | | | | 11 |
| 53 | | | | | | 43 |
| 54 | | | | | | 27 |
| 55 | | | | | | 59 |
| 56 | | | | | | 7 |
| 57 | | | | | | 39 |
| 58 | | | | | | 23 |
| 59 | | | | | | 55 |
| 60 | | | | | | 15 |
| 61 | | | | | | 47 |
| 62 | | | | | | 31 |
| 63 | | | | | | 63 |

Table 6 has a column marked (#) at the left side, starting at 0, and proceeding to Power-of-Two columns. The table is a transform table that shows for each row where Column # can be a position in a Connection Domain and the appropriate Power-of-Two column shows the row in the Space Time Domain. A plurality of connections can be denoted in Column #. The amount of bandwidth allocated to each connection is determined by the contiguous number of positions denoted.

Each position of Column # can denote a quantum of bandwidth to be applied to a connection. A frame of cellets is sent periodically; the number of frames can determine the bandwidth assigned to a single cellet if each cellet is one-bit long. The period of the frames can be set for a value for the duration of connection. For a one-bit cellet, the cellet's length divided by the frame period of the bandwidth of each cellet. The length of a cellet multiplied by a frame rate can equal its bandwidth. For example, if the frame rate is 10,000 frames per second, the bandwidth is 10,000 bits per second and the entire frame is 500 kilobits per second. As another example, for a frame having a length of 50 bits, 39 bits per frame can be used based on a list of connections as 3, 5, 2, 10, 12, 6, 1, or a total of 390 kilobits per seconds. The remaining 11 bits may be used in another set of lower-speed bandwidths using 13,000 kilobits per second.

After finding where the connections exist in the 39 and 11 sets of bandwidth, it may be necessary to find those cellet positions that are outside a total of 0 to 49 cellets. Their bandwidths are each zero bits long. This method begins with the Column #.

An embodiment can make use of the fact that the algorithm is symmetric. Such an embodiment can start with the Column # being the Space Time Domain. This can simplify the process. Using the Space Time Domain as the Column #, the process can comprise looking at each of the values of (for this example) Column 6 of 64 entries until either the end, the system has exhausted the required number of cellet positions available, or the total number of cellets have been chosen (e.g., for the example case above, the 39 and 11 cellets have been included in the process). Starting with the first row of Table 6, determine if the Column # value is greater than 50 or higher, skip the current row and look at the next.

As long as the current position is less than 50, look at Column 6 and decide if the value of Column 6 should be placed into a list of Space Time Domain Column # values. The work in looking has been done to designate where the Space Time Domain value belongs to either the 39-cellet-size connections or the 11-cellet connections. The detailed connection numbers of the 39 cellet are shown as a connection number associated with the range and not the range itself. For example, in the 3-cellet the number of the connection can be called number ‘1’ that is shown as the range 0, 1, 2; the ‘1’ is shown for each of the three cellets arriving in a Connection Domain order 0, 2, 1 at positions, all three are labeled ‘1’. For the 5-cellet connection ‘2’ would include cellets 3, 4, 5, 6, 7 arrive in order as 4, 6, 5, 3, 7 at location 8, 24, 40, 48, 55. The order of each of the connections can be informative at the source location and the destination location. Spacing in a frame for both locations can be what matters. The order in the Connection Domain maybe irrelevant. The Space Time Domain locations in a frame can determine the operation.

Routing in an Xnet does not forward data packets hop by-hop. All data connections being forwarded from one location to another can be routed. First, each single packet and each packet in a packet flow can change their forms. Each packet form for a single packet can become a small connection flow and a packet flow can become a continuous flow of connections instead of hop-by-hop packets. To overcome the burstiness and asynchronous arrival of packets that is prevalent in current Internet networks, data can be in a connection form in an Xnet. A connection in this form is called a forwarding connection and is abbreviated as an Fconnection.

An Xnet can aggregate a plurality of Fconnections from one location in a network to another location where the aggregation can be disaggregated into the plurality of Fconnections to data sinks. This aggregation and disaggregation can be a first of several levels of aggregations in an Xnet. This aggregation-disaggregation level is called Path Level 1. It and all forwarding aggregations can be single hop.

The model network described in U.S. Pat. No. 8,635,347 which is incorporated by reference herein in its entirety, and U.S. Pat. No. 9,137,201 which is incorporated by reference herein in its entirety use a network with 20 T Nodes, 500 E Nodes (distributed to an average of 25 E Node per T-Node), and a large number of Path Level 1 connections from a sE Node to a dE Node. The reason ‘a large number’ may not have a numeric limit is that a network's limits are based on 1) trunk and link bandwidths; and 2) how many connections can be handled between data sources and data sinks. A trunk bandwidth is the sum of data rates of a number of physical connections between one node and a neighbor node. A link bandwidth is the data rate allocated from the trunks between a data connection in one network node and a destination node.

An E Node can connect to a very large Path Level 1 data sources—for example, an average of 20,000 to 30,000 (e.g., 25,000) data source at a source location and 20,000 to 30,000 (e.g., 25,000) data sinks at a destination location. The 25,000 data sources can divide into 500 connections since that is the number of E Nodes in the example network. If every one of the 25,000 data sources connect to a different data sink in each of 500 E-Node, there would be 25,000/500=50 disjoint connections from each sE Node to each dE Node.

Each T-Node connects to a cluster of E-Nodes, each of which can be divided into two sub-nodes, an sE Node with a dE-Node. Each E-Node can contain a cluster of data sources and data sinks at the same location.

A Path Level 1, at one location, can be an aggregate of a plurality of Fconnection data sources. At another location the aggregated Fconnections disaggregate into paired data sinks with each data source.

In the model network, there is an average of 25 E Nodes as a cluster in each of 20 T Nodes. Path Level 1 aggregations can exist for the actual number of E Nodes in each of the 20 T Nodes. Further, assume each of the 20 T Nodes is given a number 0, 1 . . . , 19 and each of the number of 20 T Nodes are presented in Table 7 below.

TABLE 7
A Table of Example Network with 20 T-nodes with the number of E-nodes in each
T-node

| | T-Node | | | | | | | | | | | | | | | | | | | |
|---|---|---|---|---|---|---|---|---|---|---|---|---|---|---|---|---|---|---|---|---|
| | 0 | 1 | 2 | 3 | 4 | 5 | 6 | 7 | 8 | 9 | 0 | 11 | 12 | 13 | 14 | 15 | 16 | 17 | 18 | 19 |
| Nbr E-Nodes | 27 | 23 | 26 | 20 | 24 | 31 | 33 | 22 | 26 | 18 | 31 | 25 | 10 | 20 | 33 | 28 | 24 | 26 | 30 | 23 |

Assuming the number of E Nodes are 22 for a T Node 7. For each of the 22 there may be connectivity to each of the other 19 T Nodes. The use of the Xswitches comprising two domains: a Connection Domain and a Space Time Domain, including a plurality of Path Level 1 connections between an E Node Level 2 aggregation, can provide connectivity between various T-nodes simply and efficiently. An sXswitch-dXswitch pair can be simple and inexpensive in software and can be even more inexpensive in hardware. An embodiment can aggregate every forwarding E Node Level 2 from each sE Node to every dE Node in each T Node.

If there were only one T Node in a network, there may be 500 sE Nodes connecting to 500 dE Nodes, e.g., there may be 500 E Node Level 2 as a way to make forwarding decisions between Path Level 1 data sources to data sinks. Whatever the number of T Nodes in a network, it can be a multiplier of the number of E Node in a network. Both the T Nodes and the E Node can be much cheaper and clock rates and reliability more reasonable.

Each of the processes, methods, and algorithms described herein and/or depicted in the attached figures may be embodied in, and fully or partially automated by, code modules executed by one or more physical computing systems, hardware computer processors, application-specific circuitry, and/or electronic hardware configured to execute specific and particular computer instructions. For example, computing systems can include general purpose computers (e.g., servers) programmed with specific computer instructions or special purpose computers, special purpose circuitry, and so forth. A code module may be compiled and linked into an executable program, installed in a dynamic link library, or may be written in an interpreted programming language. In some implementations, particular operations and methods may be performed by circuitry that is specific to a given function.

Further, certain implementations of the functionality of the present disclosure are sufficiently mathematically, computationally, or technically complex that application-specific hardware or one or more physical computing devices (utilizing appropriate specialized executable instructions) may be necessary to perform the functionality, for example, due to the volume or complexity of the calculations involved or to provide results substantially in real-time. For example, a video may include many frames, with each frame having millions of pixels, and specifically programmed computer hardware is necessary to process the video data to provide a desired image processing task or application in a commercially reasonable amount of time.

Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed processes or process steps may be stored, persistently or otherwise, in any type of non-transitory, tangible computer storage or may be communicated via a computer-readable transmission medium.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted can be incorporated in the example methods and processes that are schematically illustrated. For example, one or more additional operations can be performed before, after, simultaneously, or between any of the illustrated operations. Additionally, the operations may be rearranged or reordered in other implementations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A scalable data forwarding network configured to reduce latency and improve efficiency and security, the network comprising:
an aggregator configured to accept data in packet form from multiple data sources and change that data from packet form into a stream of bits;
a disaggregator configured to receive the stream of bits from an aggregator, change the stream into packet form, and then convey the data to multiple data sinks that correspond to the data sources to form pairs;
a one-hop connection having a total bandwidth that connects the aggregator and the disaggregator and transfers the stream of bits between the aggregator and the disaggregator;
a controller configured to determine the bandwidth required by each of the multiple pairs of data sources and data sinks prior to any data flow for a given pair and allocate bandwidth within the total bandwidth of the one-hop connection to each of these pairs, thereby initially dedicating bandwidth to that pair, the controller using a control vector comprising a separate, out-of-band control connection with the aggregator and disaggregator to control this bandwidth allocation;
the controller further configured to periodically determine bandwidth needed for each pair and update the control vector to dynamically allocate bandwidth according to information regarding data from the each source;
the controller configured to maintain a database that assigns a unique address to each source and sink, assigns connection numbers for each communicating pair when requested, and shows the locations of each communicating source, sink, and pair in real time;
the controller further configured to establish at least one sleep mode connection for some pairs for which it predicts burst problems by maintaining a connection number and location (even with no bandwidth is currently required) in order to more quickly prepare for future bursts of data that will suddenly require greater bandwidth;
the network configured to provide security and connection privacy by maintaining each pair of data source and sink disjoint such that each pair may have its own input-output data protocol such that a pair using IPv4 protocol and a pair using IPv6 protocol can exist and communicate with each other simultaneously.

2. The network of claim 1, further configured to provide security by determining that an arriving packet is part of a flow of data packets, using a numeric header in the arriving data packet to be part of a control vector for the pair connection that will handle that packet flow, and identifying each successive packet in that packet flow with the same numeric header.

3. The network of claim 2, wherein the controller is configured to use the arrival of each packet in the packet flow as a trigger to replace the connection number with a header of the original packet in that packet flow and improve security by, using the numeric header numbers as identifiers, using a security control vector to send a shuffle of the numeric header numbers for different packet flow connections, thereby requiring the information from the control vector shuffle to decode the data.

4. The network of claim 1, further configured to provide security by removing a portion of a packet header containing length information and forwarding that length portion independently from the rest of the packet over an independent control vector.

5. A method for forwarding data from a source to a destination, the method comprising:
aggregating a plurality of packets at the source to generate a frame comprising a plurality of cellets, each cellet representing a quantum of data bandwidth;
setting up one or more connections between the source and the destination;
allocating bandwidth for the one or more connections based on a number of the plurality of cellets in the generated frame;
distributing the cellets substantially uniformly within the frame;
forwarding the generated frame over the one or more connections to the destination; and
disaggregating the frame and transferring the plurality of packets to data sinks.

6. The method of claim 5, wherein allocating the bandwidth comprises identifying a position in a connection domain of a transform table.

7. The method of claim 5, wherein distributing the cellets comprises identifying a position in a space time domain of a transform table.

8. A system configured to forward data from a source to a destination, the system comprising:
an aggregator to combine a plurality of packets at the source and generate a frame comprising a plurality of cellets, each cellet representing a quantum of data bandwidth;
one or more electronic processors configured to set up one or more connections between the source and the destination;
a database comprising:
a connection domain that allocates bandwidth for the one or more connections based on a number of the plurality of cellets in the generated frame; and
a space time domain that distributes the cellets substantially uniformly within the generated frame; and
a disaggregator configured to deaggregate the frame and transfer the plurality of packets to data sinks.
